(19) United States
(12) Patent Application Publication
(10) Pub. No.: US 2019/0179611 A1
(43) Pub. Date: Jun. 13, 2019

(54) Systems and Methods of Receiving Voice Input

(71) Applicant: Sonos, Inc., Santa Barbara, CA (US)

(72) Inventors: Kate Wojogbe, Santa Barbara, CA (US); Andrew Lindley, Los Angeles, CA (US); Chuck Freedman, Boston, MA (US); Dayn Wilberding, Santa Barbara, CA (US)

(21) Appl. No.: 16/179,779

(22) Filed: Nov. 2, 2018

Related U.S. Application Data
(60) Provisional application No. 62/597,408, filed on Dec. 11, 2017.

(51) Int. Cl. G06F 3/16; H04W 52/02; G10L 15/08; G10L 15/30; H04R 3/04; H04L 29/06

(52) U.S. Cl. CPC G06F 3/167; H04W 52/0222; H04W 52/0235; G10L 15/08; H04R 2430/01; H04R 3/04; H04L 65/40; G10L 2015/088; G10L 15/30

(57) ABSTRACT

Systems and methods of receiving voice input are disclosed herein. In one embodiment, for example, a network microphone device is configured to cause an output of a feedback element only if received voice input data comprises the valid wake word. In another embodiment, for example, a network microphone device is configured to determine a type of command request in voice input data, and cause output of a feedback element corresponding to the determined type of command request. In one embodiment, for example, a media playback system is configured to play back media content via first and second playback devices, and further configured to cause output, via the second playback device, of a feedback element corresponding to voice input received at the second playback device.

### CROSS-REFERENCE TO RELATED APPLICATION(S)

The present application claims the benefit of priority to U.S. Provisional Application No. 62/597,408, titled “Systems and Methods of Receiving Voice Input,” filed Dec. 11, 2017, which is incorporated by reference herein in its entirety.

### FIELD OF THE DISCLOSURE

The disclosure is related to consumer goods and, more particularly, to methods, systems, products, features, services, and other elements directed to voice control of media playback or some aspect thereof.

### BACKGROUND

Options for accessing and listening to digital audio in an out-loud setting were limited until in 2003, when SONOS, Inc. filed for one of its first patent applications, entitled “Method for Synchronizing Audio Playback between Multiple Networked Devices,” and began offering a media playback system for sale in 2005. The Sonos Wireless HiFi System enables people to experience music from many sources via one or more networked playback devices. Through a software control application installed on a smartphone, tablet, or computer, one can play what he or she wants in any room that has a networked playback device. Additionally, using the controller, for example, different songs can be streamed to each room with a playback device, rooms can be grouped together for synchronous playback, or the same song can be heard in all rooms synchronously.

### BRIEF DESCRIPTION OF THE DRAWINGS

Features, aspects, and advantages of the presently disclosed technology may be better understood with regard to the following description, appended claims, and accompanying drawings where:

FIG. 1 shows a media playback system in which certain embodiments may be practiced;

FIG. 2A is a functional block diagram of an example playback device;

FIG. 2B is an isometric diagram of an example playback device that includes a network microphone device;

FIGS. 3A, 3B, 3C, 3D, and 3E are diagrams showing example zones and zone groups in accordance with aspects of the disclosed technology;

FIG. 4A is a functional block diagram of an example controller device in accordance with aspects of the disclosed technology;

FIGS. 4B and 4C are controller interfaces in accordance with aspects of the disclosed technology;

FIG. 5A is a functional block diagram of an example network microphone device in accordance with aspects of the disclosed technology;

FIG. 5B is a diagram of an example voice input in accordance with aspects of the disclosed technology;

FIG. 6 is a functional block diagram of example remote computing device(s) in accordance with aspects of the disclosed technology;

FIG. 7A is a schematic diagram of an example network system in accordance with aspects of the disclosed technology;

FIG. 7B is an example message flow implemented by the example network system of FIG. 7A in accordance with aspects of the disclosed technology;

FIG. 8A is a flow diagram of a process configured to receive voice input in accordance with aspects of the disclosed technology;

FIG. 8B is a functional flow diagram of an example method of receiving voice input;

FIG. 9 is a flow diagram of a process configured to determine a feedback element in accordance with aspects of the disclosed technology;

FIGS. 10A and 10B are schematic diagrams of examples of voice input and associated feedback elements in accordance with aspects of the disclosed technology;

FIG. 11A is a flow diagram of a process configured to output a feedback element to one or more corresponding playback devices in accordance with aspects of the disclosed technology;

FIG. 11B is a schematic diagram of an example method of directing a feedback element; and

FIGS. 12A-12D are schematic diagrams of example methods of directing a feedback element.

The drawings are for purposes of illustrating example embodiments, but it is understood that the inventions are not limited to the arrangements and instrumentality shown in the drawings.

### DETAILED DESCRIPTION

### I. OVERVIEW

4 Voice control can be beneficial for a “smart” home having smart appliances and related devices, such as wireless illumination devices, home-automation devices (e.g., thermostats, door locks, etc.), and audio playback devices. In some implementations, networked microphone devices may be used to control smart home devices. A network microphone device will typically include a microphone for receiving voice inputs. The network microphone device can forward voice inputs to a voice assistant service (VAS). A traditional VAS may be a remote service implemented by cloud servers to process voice inputs. A VAS may process a voice input to determine an intent of the voice input. Based on the response, the network microphone device may cause one or more smart devices to perform an action. For example, the network microphone device may instruct an illumination device to turn on/off based on the response to the instruction from the VAS.

A voice input detected by a network microphone device will typically include a wake word followed by an utterance containing a user request. The wake word is typically a predetermined word or phrase used to “wake up” and invoke the VAS for interpreting the intent of the voice input. For instance, in querying the AMAZON® VAS, a user might speak the wake word “Alexa.” Other examples include “Ok, Google” for invoking the GOOGLE® VAS and “Hey, Siri” for invoking the APPLE® VAS, or “Hey, Sonos” for a VAS offered by SONOS®.

A network microphone device listens for a user request or command accompanying a wake word in the voice input. In some instances, the user request may include a command to control a third-party device, such as a thermostat (e.g., NEST® thermostat), an illumination device (e.g., a PHILIPS HUE® lighting device), or a media playback device (e.g., a Sonos® playback device). For example, a user might speak the wake word “Alexa” followed by the utterance “set the thermostat to 68 degrees” to set the temperature in a home using the Amazon® VAS. A user might speak the same wake word followed by the utterance “turn on the living room” to turn on illumination devices in a living room area of the home. The user may similarly speak a wake word followed by a request to play a particular song, an album, or a playlist of music on a playback device in the home.

A VAS may employ natural language understanding (NLU) systems to process voice inputs. NLU systems typically require multiple remote servers that are programmed to detect the underlying intent of a given voice input. For example, the servers may maintain a lexicon of language; parsers; grammar and semantic rules; and associated processing algorithms to determine the user's intent.

In one embodiment, for example, a method can include receiving voice input data via at least one microphone, and determining whether the voice input data comprises a valid wake word. The method can further include causing output of the feedback element only if the voice input data comprises the valid wake word and at least one command request. In some aspects, determining that the voice input data comprises a valid wake word can comprise receiving, via a network interface, an indication from a voice assistant service that the received voice input data comprises the valid wake word. In some aspects, the method can further include suppressing output of the feedback element in the absence of the valid wake word in the voice input data. In certain aspects, the method can further include delaying output of the feedback element a time after determining whether the voice input data comprises the valid wake word and determining whether the voice input data comprises the at least one command request.

In another embodiment, for example, a method can include receiving voice input data via the at least one microphone and determining a type of command request in the voice input data. The method can further include determining, in response to determining the type of command request in the voice input data, a feedback element corresponding to the determined type of command request. In response to determining the feedback element, the method may also include causing, via the media playback system, output of the feedback element. In some aspects, the method further includes determining the feedback element corresponding to the determined type of command request and a determined category of media content. In certain aspects, the method can also include performing an action corresponding to the command request in the absence of a feedback element.

In yet another embodiment, a method can include receiving voice input data via at least one microphone and determining a feedback element corresponding to a command request in the voice input data. The method may also include causing output of the determined feedback element, wherein causing output of the feedback element comprises, during playback of media content via the first playback device and playback of the same media content via the second playback device, causing output of the feedback element via the second playback device in the absence of output of the feedback element via first playback device. In some aspects, the method can also include playing back, via the second playback device, the media content at a second volume level while the media content is played back via the first playback device at the first volume level. In one aspect, playback of the media content via the second playback device is reduced from the second volume level to a third, lower volume level. In certain aspects, the feedback element is output at a fourth volume level while the media content plays back via the first playback device at the first volume level and via the second playback device at the third volume level. In some aspects, the feedback element is output at the fourth volume level while the second playback device plays back the media content at the third volume level in synchrony with the first playback device playing back the media content at the first volume level.

In some aspects, media content is played back via the first playback device at the first volume level and a third playback device at the second volume level while the feedback element is output at the fourth volume level.

In some aspects of the technology, the network microphone device may comprise one or more processors, at least one microphone and tangible computer-readable memory storing instructions that, when executed by the one or more processors, cause the network microphone device to perform operations for determining a feedback element for output. In some embodiments, the operations may comprise playing back media content. The operations may further comprise receiving voice input data via the at least one microphone while playing back the media content. The operations may further comprise determining a feedback parameter derived from the voice input data, the media content, and/or secondary data, and causing output of a feedback element. In some embodiments, causing output of the feedback element includes determining whether the feedback element includes an audio component, a visual component, or both based on the determined feedback parameter.

Several aspects of the technology include a media playback system comprising a network microphone device having at least one microphone. The media playback system may optionally include additional network microphone devices and/or playback devices. The media playback system may comprise one or more processors and tangible computer-readable memory storing instructions that, when executed by the one or more processors, cause the network microphone device to perform operations for determining a feedback element for output. In some embodiments, the operations may comprise playing back media content via the network microphone device and/or another playback device of the media playback system. The operations may further comprise receiving voice input data via the at least one microphone while playing back the media content. The operations may further comprise determining a feedback parameter derived from the voice input data, the media content, and/or secondary data, and causing output of a feedback element. In some embodiments, causing output of the feedback element includes determining whether the feedback element includes an audio component, a visual component, or both based on the determined feedback parameter.

Several aspects of the technology include tangible computer-readable memory storing instructions that, when executed by the one or more processors, cause a network microphone device having at least one microphone to perform operations for determining a feedback element for output. In some embodiments, the operations may comprise playing back media content via the network microphone device and/or another playback device. The operations may further comprise receiving voice input data via the at least one microphone while playing back the media content. The operations may further comprise determining a feedback parameter derived from the voice input data, the media content, and/or secondary data, and causing output of a feedback element. In some embodiments, causing output of the feedback element includes determining whether the feedback element includes an audio component, a visual component, or both based on the determined feedback parameter.

In some embodiments, the feedback parameter may be a first feedback parameter, and the operations may comprise determining a second feedback parameter. In some aspects, the first feedback parameter may be derived from one of the voice input data, the media content, and the secondary data, and the second feedback parameter may be derived from another of the voice input data, the media content, and the secondary data.

In some embodiments, the feedback parameter may be a first feedback parameter, and the operations may comprise determining a second feedback parameter and a third feedback parameter. The first feedback parameter may be derived from the voice input data, the second feedback parameter may be derived from the media content, and the third feedback parameter may be derived from the secondary data.

In some embodiments, the operations may comprise determining at least two feedback parameters derived from the voice input data. In some aspects, the operations may comprise determining at least two feedback parameters derived from the media content. The operations may comprise determining at least two feedback parameters derived from the secondary data in some embodiments.

In several aspects of the technology, the feedback parameter may be derived from the voice input data and may be a command or a command type. In such embodiments, the command type can be a content-related command or a content-independent command. When the feedback parameter is content-related, the operations may output only a visual (and not audio) feedback element.

In some embodiments, the feedback parameter may be derived from the media content and may be a media content type or a media content sub-type. In such embodiments, the media content type may be a movie, a television show, an audiobook, a podcast, or music.

In some embodiments, the feedback parameter is derived from the secondary data and comprises a group in which the network microphone device belongs, a zone in which the network microphone device belongs, a volume at which the media content is being played back when the voice input data is received, the input interface over which the media content is received, a particular user profile, and a location of the network microphone device relative to the user providing the voice input data.

In several aspects of the technology, the operations further include determining whether the voice input data is related to the media content being played back by the network microphone device. In such embodiments, the operations may further include determining the voice input data is related to the media content being played back and, based on the determination that the voice input data is related to the media content, outputting only a visual feedback element and not an audio element. The operations may further include determining the voice input data is related to the media content being played back and, based on the determination that the voice input data is related to the media content, outputting only a visual feedback element.

In some aspects, when the feedback parameter is indicative of the media content being a podcast, an audiobook, media content related to a movie, or media content related to a television show, the operations comprises outputting only a visual feedback element.

While some embodiments described herein may refer to functions performed by given actors such as “users” and/or other entities, it should be understood that this description is for purposes of explanation only. The claims should not be interpreted to require action by any such example actor unless explicitly required by the language of the claims themselves.

### II. EXAMPLE OPERATING ENVIRONMENT

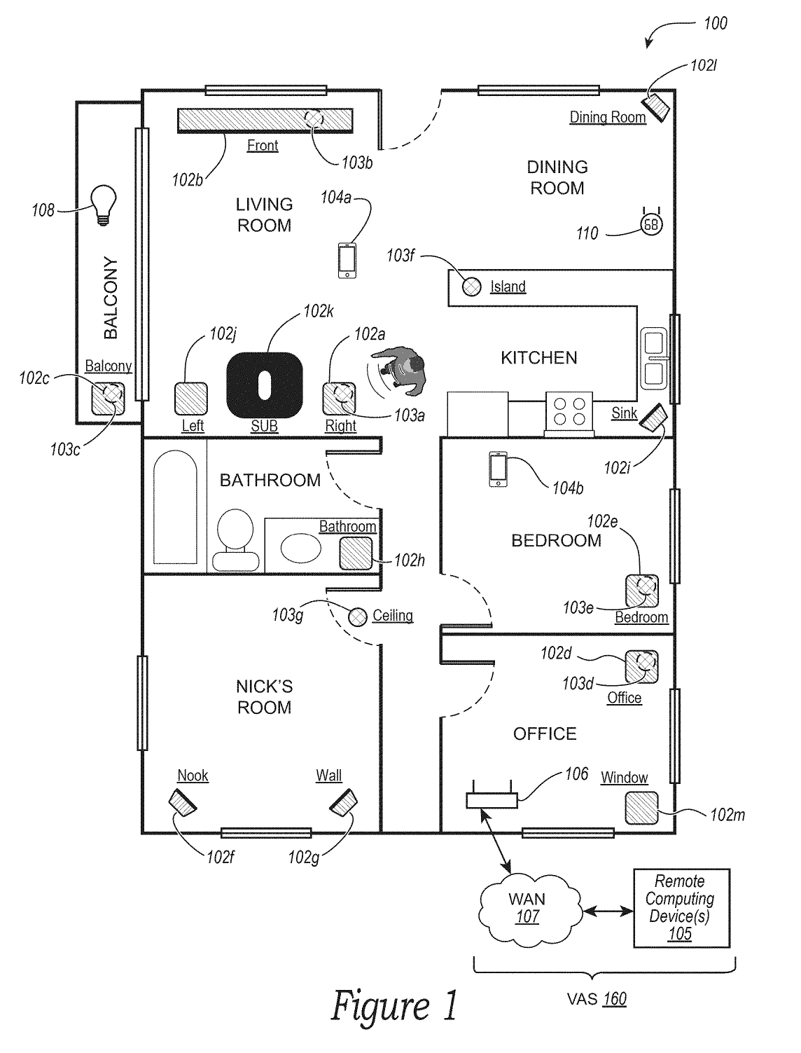

FIG. 1 illustrates an example configuration of a media playback system 100 in which one or more embodiments disclosed herein may be implemented. The media playback system 100 as shown is associated with an example home environment having several rooms and spaces, such as for example, an office, a dining room, and a living room. Within these rooms and spaces, the media playback system 100 includes playback devices 102 (identified individually as playback devices 102a-102m), network microphone devices 103 (identified individually as “NMD(s)” 103a-103g), and controller devices 104a and 104b (collectively “controller devices 104”). The home environment may include other network devices, such as one or more smart illumination devices 108 and a smart thermostat 110.

The various playback, network microphone, and controller devices 102-104 and/or other network devices of the media playback system 100 may be coupled to one another via point-to-point connections and/or over other connections, which may be wired and/or wireless, via a LAN including a network router 106. For example, the playback device 102j (designated as “Left”) may have a point-to-point connection with the playback device 102a (designated as “Right”). In one embodiment, the Left playback device 102j may communicate over the point-to-point connection with the Right playback device 102a. In a related embodiment, the Left playback device 102j may communicate with other network devices via the point-to-point connection and/or other connections via the LAN.

The network router 106 may be coupled to one or more remote computing device(s) 105 via a wide area network (WAN) 107. In some embodiments, the remote computing device(s) may be cloud servers. The remote computing device(s) 105 may be configured to interact with the media playback system 100 in various ways. For example, the remote computing device(s) may be configured to facilitate streaming and controlling playback of media content, such as audio, in the home environment. In one aspect of the technology described in greater detail below, the remote computing device(s) 105 are configured to provide a first VAS 160 for the media playback system 100.

In some embodiments, one or more of the playback devices 102 may include an on-board (e.g., integrated) network microphone device. For example, the playback devices 102a-e include corresponding NMDs 103a-e, respectively. Playback devices that include network microphone devices may be referred to herein interchangeably as a playback device or a network microphone device unless indicated otherwise in the description.

In some embodiments, one or more of the NMDs 103 may be a stand-alone device. For example, the NMDs 103f and 103g may be stand-alone network microphone devices. A stand-alone network microphone device may omit components typically included in a playback device, such as a speaker or related electronics. In such cases, a stand-alone network microphone device may not produce audio output or may produce limited audio output (e.g., relatively low-quality audio output).

In use, a network microphone device may receive and process voice inputs from a user in its vicinity. For example, a network microphone device may capture a voice input upon detection of the user speaking the input. In the illustrated example, the NMD 103a of the playback device 102a in the Living Room may capture the voice input of a user in its vicinity. In some instances, other network microphone devices (e.g., the NMDs 103b and 103f) in the vicinity of the voice input source (e.g., the user) may also detect the voice input. In such instances, network microphone devices may arbitrate between one another to determine which device(s) should capture and/or process the detected voice input. Examples for selecting and arbitrating between network microphone devices may be found, for example, in U.S. patent Ser. No. 15/721,141, titled “Media Playback System with Voice Assistance, filed Sep. 29, 2017, which is incorporated by reference herein in its entirety.

In certain embodiments, a network microphone device may be assigned to a playback device that may not include a network microphone device. For example, the NMD 103f may be assigned to the playback devices 102i and/or 102l in its vicinity. In a related example, a network microphone device may output audio through a playback device to which it is assigned. Additional details regarding associating network microphone devices and playback devices as designated or default devices may be found, for example, in U.S. patent Ser. No. 15/721,141, titled “Media Playback System with Voice Assistance, filed Sep. 29, 2017, which is incorporated by reference herein in its entirety.

Further aspects relating to the different components of the example media playback system 100 and how the different components may interact to provide a user with a media experience may be found in the following sections. While discussions herein may generally refer to the example media playback system 100, technologies described herein are not limited to applications within, among other things, the home environment as shown in FIG. 1. For instance, the technologies described herein may be useful in other home environment configurations comprising more or fewer of any of the playback, network microphone, and/or controller devices 102-104. Additionally, the technologies described herein may be useful in environments where multi-zone audio may be desired, such as, for example, a commercial setting like a restaurant, mall or airport, a vehicle like a sports utility vehicle (SUV), bus or car, a ship or boat, an airplane, and so on.

a. Example Playback and Network Microphone Devices

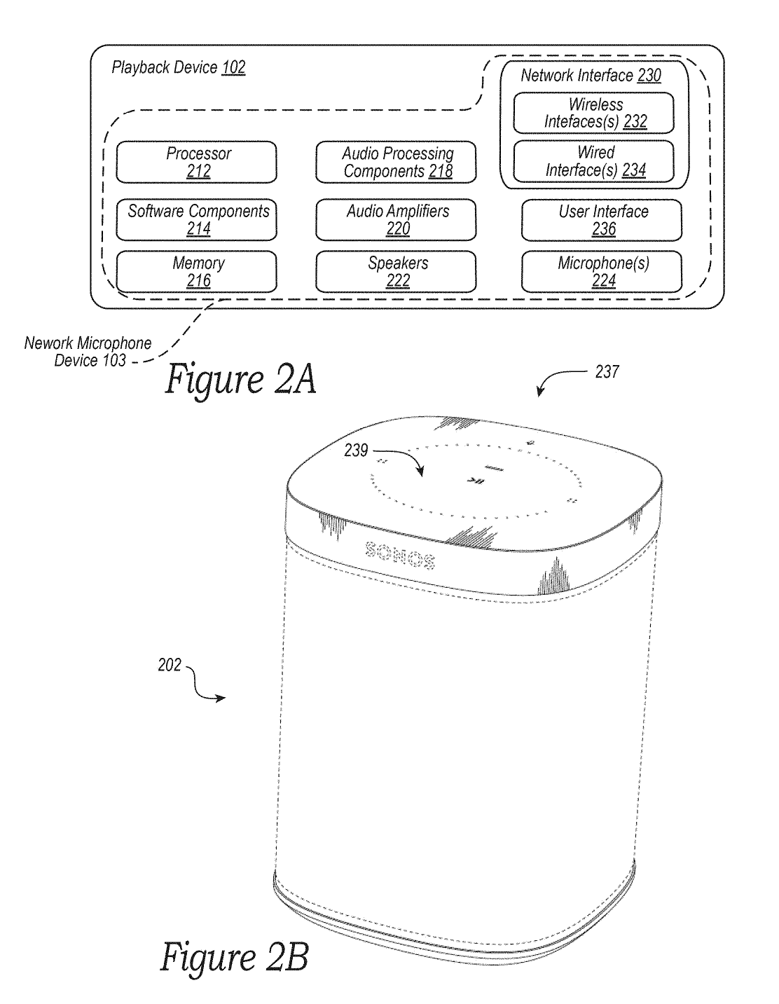

FIG. 2A is a functional block diagram illustrating certain aspects of a selected one of the playback devices 102 shown in FIG. 1. As shown, such a playback device may include a processor 212, software components 214, memory 216, audio processing components 218, audio amplifier(s) 220, speaker(s) 222, and a network interface 230 including wireless interface(s) 232 and wired interface(s) 234. In some embodiments, a playback device may not include the speaker(s) 222, but rather a speaker interface for connecting the playback device to external speakers. In certain embodiments, the playback device may include neither the speaker(s) 222 nor the audio amplifier(s) 222, but rather an audio interface for connecting a playback device to an external audio amplifier or audio-visual receiver.

A playback device may further include a user interface 236. The user interface 236 may facilitate user interactions independent of or in conjunction with one or more of the controller devices 104. In various embodiments, the user interface 236 includes one or more of physical buttons and/or graphical interfaces provided on touch sensitive screen(s) and/or surface(s), among other possibilities, for a user to directly provide input. The user interface 236 may further include one or more of lights and the speaker(s) to provide visual and/or audio feedback to a user.

In some embodiments, the processor 212 may be a clock-driven computing component configured to process input data according to instructions stored in the memory 216. The memory 216 may be a tangible computer-readable medium configured to store instructions executable by the processor 212. For example, the memory 216 may be data storage that can be loaded with one or more of the software components 214 executable by the processor 212 to achieve certain functions. In one example, the functions may involve a playback device retrieving audio data from an audio source or another playback device. In another example, the functions may involve a playback device sending audio data to another device on a network. In yet another example, the functions may involve pairing of a playback device with one or more other playback devices to create a multi-channel audio environment.

Certain functions may involve a playback device synchronizing playback of audio content with one or more other playback devices. During synchronous playback, a listener may not perceive time-delay differences between playback of the audio content by the synchronized playback devices. U.S. Pat. No. 8,234,395 filed Apr. 4, 2004, and titled “System and method for synchronizing operations among a plurality of independently clocked digital data processing devices” provides in more detail some examples for audio playback synchronization among playback devices.

The audio processing components 218 may include one or more digital-to-analog converters (DAC), an audio preprocessing component, an audio enhancement component or a digital signal processor (DSP), and so on. In some embodiments, one or more of the audio processing components 218 may be a subcomponent of the processor 212. In one example, audio content may be processed and/or intentionally altered by the audio processing components 218 to produce audio signals. The produced audio signals may then be provided to the audio amplifier(s) 210 for amplification and playback through speaker(s) 212. Particularly, the audio amplifier(s) 210 may include devices configured to amplify audio signals to a level for driving one or more of the speakers 212. The speaker(s) 212 may include an individual transducer (e.g., a “driver”) or a complete speaker system involving an enclosure with one or more drivers. A particular driver of the speaker(s) 212 may include, for example, a subwoofer (e.g., for low frequencies), a mid-range driver (e.g., for middle frequencies), and/or a tweeter (e.g., for high frequencies). In some cases, each transducer in the one or more speakers 212 may be driven by an individual corresponding audio amplifier of the audio amplifier(s) 210. In addition to producing analog signals for playback, the audio processing components 208 may be configured to process audio content to be sent to one or more other playback devices for playback.

Audio content to be processed and/or played back by a playback device may be received from an external source, such as via an audio line-in input connection (e.g., an auto-detecting 3.5 mm audio line-in connection) or the network interface 230.

The network interface 230 may be configured to facilitate a data flow between a playback device and one or more other devices on a data network. As such, a playback device may be configured to receive audio content over the data network from one or more other playback devices in communication with a playback device, network devices within a local area network, or audio content sources over a wide area network such as the Internet. In one example, the audio content and other signals transmitted and received by a playback device may be transmitted in the form of digital packet data containing an Internet Protocol (IP)-based source address and IP-based destination addresses. In such a case, the network interface 230 may be configured to parse the digital packet data such that the data destined for a playback device is properly received and processed by the playback device.

As shown, the network interface 230 may include wireless interface(s) 232 and wired interface(s) 234. The wireless interface(s) 232 may provide network interface functions for a playback device to wirelessly communicate with other devices (e.g., other playback device(s), speaker(s), receiver(s), network device(s), control device(s) within a data network the playback device is associated with) in accordance with a communication protocol (e.g., any wireless standard including IEEE 802.11a, 802.11b, 802.11g, 802.11n, 802.11ac, 802.15, 4G mobile communication standard, and so on). The wired interface(s) 234 may provide network interface functions for a playback device to communicate over a wired connection with other devices in accordance with a communication protocol (e.g., IEEE 802.3). While the network interface 230 shown in FIG. 2A includes both wireless interface(s) 232 and wired interface(s) 234, the network interface 230 may in some embodiments include only wireless interface(s) or only wired interface(s).

As discussed above, a playback device may include a network microphone device, such as one of the NMDs 103 shown in FIG. 1. A network microphone device may share some or all the components of a playback device, such as the processor 212, the memory 216, the microphone(s) 224, etc. In other examples, a network microphone device includes components that are dedicated exclusively to operational aspects of the network microphone device. For example, a network microphone device may include far-field microphones and/or voice processing components, which in some instances a playback device may not include. In another example, a network microphone device may include a touch-sensitive button for enabling/disabling a microphone. In yet another example, a network microphone device can be a stand-alone device, as discussed above. FIG. 2B is an isometric diagram showing an example playback device 202 incorporating a network microphone device. The playback device 202 has a control area 237 at the top of the device for enabling/disabling microphone(s). The control area 237 is adjacent another area 239 at the top of the device for controlling playback.

By way of illustration, SONOS, Inc. presently offers (or has offered) for sale certain playback devices including a “PLAY:1,” “PLAY:3,” “PLAY:5,” “PLAYBAR,” “CONNECT:AMP,” “CONNECT,” and “SUB.” Any other past, present, and/or future playback devices may additionally or alternatively be used to implement the playback devices of example embodiments disclosed herein. Additionally, it is understood that a playback device is not limited to the example illustrated in FIG. 2A or to the SONOS product offerings. For example, a playback device may include a wired or wireless headphone. In another example, a playback device may include or interact with a docking station for personal mobile media playback devices. In yet another example, a playback device may be integral to another device or component such as a television, a lighting fixture, or some other device for indoor or outdoor use.

b. Example Playback Device Configurations

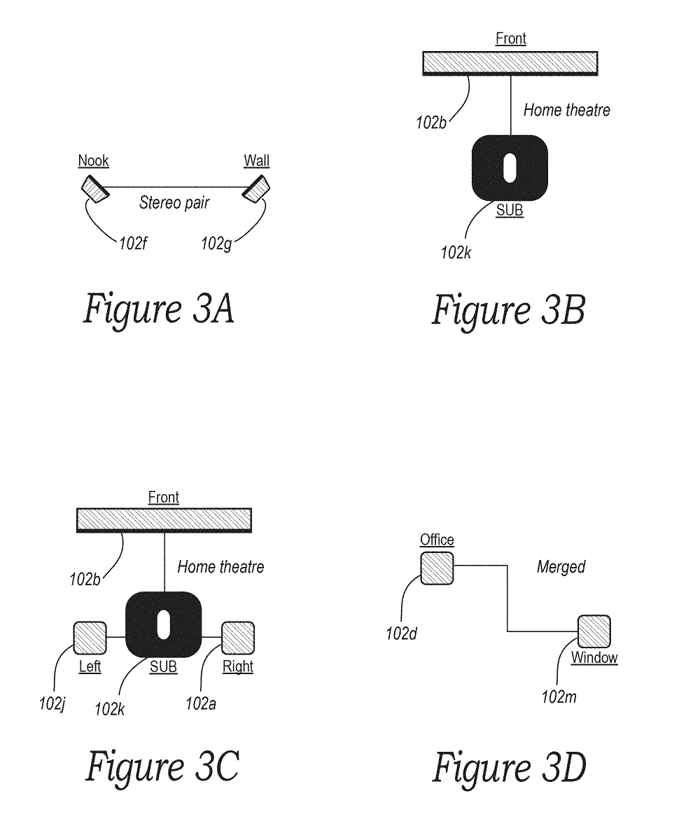

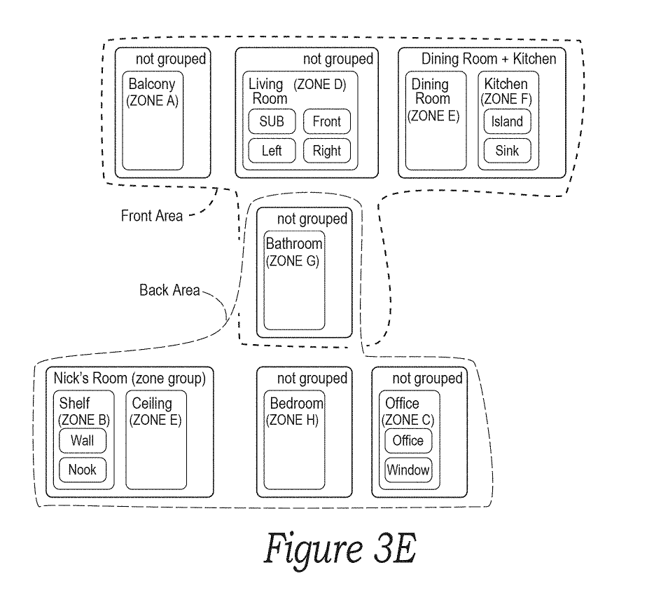

FIGS. 3A-3E show example configurations of playback devices in zones and zone groups. Referring first to FIG. 3E, in one example, a single playback device may belong to a zone. For example, the playback device 102c in the Balcony may belong to Zone A. In some implementations described below, multiple playback devices may be “bonded” to form a “bonded pair” which together form a single zone. For example, the playback device 102f named Nook in FIG. 1 may be bonded to the playback device 102g named Wall to form Zone B. Bonded playback devices may have different playback responsibilities (e.g., channel responsibilities). In another implementation described below, multiple playback devices may be merged to form a single zone. For example, the playback device 102d named Office may be merged with the playback device 102m named Window to form a single Zone C. The merged playback devices 102d and 102m may not be specifically assigned different playback responsibilities. That is, the merged playback devices 102d and 102m may, aside from playing audio content in synchrony, each play audio content as they would if they were not merged.

Each zone in the media playback system 100 may be provided for control as a single user interface (UI) entity. For example, Zone A may be provided as a single entity named Balcony. Zone C may be provided as a single entity named Office. Zone B may be provided as a single entity named Shelf.

In various embodiments, a zone may take on the name of one of the playback device(s) belonging to the zone. For example, Zone C may take on the name of the Office device 102d (as shown). In another example, Zone C may take on the name of the Window device 102m. In a further example, Zone C may take on a name that is some combination of the Office device 102d and Window device 102m. The name that is chosen may be selected by user. In some embodiments, a zone may be given a name that is different than the device(s) belonging to the zone. For example, Zone B is named Shelf but none of the devices in Zone B have this name.

Playback devices that are bonded may have different playback responsibilities, such as responsibilities for certain audio channels. For example, as shown in FIG. 3A, the Nook and Wall devices 102f and 102g may be bonded so as to produce or enhance a stereo effect of audio content. In this example, the Nook playback device 102f may be configured to play a left channel audio component, while the Wall playback device 102g may be configured to play a right channel audio component. In some implementations, such stereo bonding may be referred to as “pairing.”

Additionally, bonded playback devices may have additional and/or different respective speaker drivers. As shown in FIG. 3B, the playback device 102b named Front may be bonded with the playback device 102k named SUB. The Front device 102b may render a range of mid to high frequencies and the SUB device 102k may render low frequencies as, e.g., a subwoofer. When unbonded, the Front device 102b may render a full range of frequencies. As another example, FIG. 3C shows the Front and SUB devices 102b and 102k further bonded with Right and Left playback devices 102a and 102k, respectively. In some implementations, the Right and Left devices 102a and 102k may form surround or “satellite” channels of a home theatre system. The bonded playback devices 102a, 102b, 102j, and 102k may form a single Zone D (FIG. 3E).

Playback devices that are merged may not have assigned playback responsibilities, and may each render the full range of audio content the respective playback device is capable of. Nevertheless, merged devices may be represented as a single UI entity (i.e., a zone, as discussed above). For instance, the playback device 102d and 102m in the Office have the single UI entity of Zone C. In one embodiment, the playback devices 102d and 102m may each output the full range of audio content each respective playback device 102d and 102m are capable of, in synchrony.

In some embodiments, a stand-alone network microphone device may be in a zone by itself. For example, the NMD 103g in FIG. 1 named Ceiling may be Zone E. A network microphone device may also be bonded or merged with another device so as to form a zone. For example, the NMD device 103f named Island may be bonded with the playback device 102i Kitchen, which together form Zone G, which is also named Kitchen. Additional details regarding associating network microphone devices and playback devices as designated or default devices may be found, for example, in U.S. patent Ser. No. 15/721,141, titled “Media Playback System with Voice Assistance, filed Sep. 29, 2017, which is incorporated by reference herein in its entirety. In some embodiments, a stand-alone network microphone device may not be associated with a zone.

Zones of individual, bonded, and/or merged devices may be grouped to form a zone group. For example, referring to FIG. 3E, Zone A may be grouped with Zone B to form a zone group that includes the two zones. As another example, Zone A may be grouped with one or more other Zones C-I. The Zones A-I may be grouped and ungrouped in numerous ways. For example, three, four, five, or more (e.g., all) of the Zones A-I may be grouped. When grouped, the zones of individual and/or bonded playback devices may play back audio in synchrony with one another, as described in U.S. patent Ser. No. 15/721,141, titled “Media Playback System with Voice Assistance, filed Sep. 29, 2017, which is incorporated by reference herein in its entirety. Playback devices may be dynamically grouped and ungrouped to form new or different groups that synchronously play back audio content.

In various implementations, the zones in an environment may be the default name of a zone within the group or a combination of the names of the zones within a zone group, such as Dining Room+Kitchen, as shown in FIG. 3E. In some embodiments, a zone group may be given a unique name selected by a user, such as Nick's Room, as also shown in FIG. 3E.

Referring again to FIG. 2A, certain data may be stored in the memory 216 as one or more state variables that are periodically updated and used to describe the state of a playback zone, the playback device(s), and/or a zone group associated therewith. The memory 216 may also include the data associated with the state of the other devices of the media system, and shared from time to time among the devices so that one or more of the devices have the most recent data associated with the system.

In some embodiments, the memory may store instances of various variable types associated with the states. Variables instances may be stored with identifiers (e.g., tags) corresponding to type. For example, certain identifiers may be a first type “a1” to identify playback device(s) of a zone, a second type “b1” to identify playback device(s) that may be bonded in the zone, and a third type “c1” to identify a zone group to which the zone may belong. As a related example, in FIG. 1, identifiers associated with the Balcony may indicate that the Balcony is the only playback device of a particular zone and not in a zone group. Identifiers associated with the Living Room may indicate that the Living Room is not grouped with other zones but includes bonded playback devices 102a, 102b, 102j, and 102k. Identifiers associated with the Dining Room may indicate that the Dining Room is part of Dining Room+Kitchen group and that devices 103f and 102i are bonded. Identifiers associated with the Kitchen may indicate the same or similar information by virtue of the Kitchen being part of the Dining Room+Kitchen zone group. Other example zone variables and identifiers are described below.

In yet another example, the media playback system 100 may variables or identifiers representing other associations of zones and zone groups, such as identifiers associated with Areas, as shown in FIG. 3. An area may involve a cluster of zone groups and/or zones not within a zone group. For instance, FIG. 3E shows a first area named Front Area and a second area named Back Area. The Front Area includes zones and zone groups of the Balcony, Living Room, Dining Room, Kitchen, and Bathroom. The Back Area includes zones and zone groups of the Bathroom, Nick's Room, the Bedroom, and the Office. In one aspect, an Area may be used to invoke a cluster of zone groups and/or zones that share one or more zones and/or zone groups of another cluster. In another aspect, this differs from a zone group, which does not share a zone with another zone group. Further examples of techniques for implementing Areas may be found, for example, in U.S. application Ser. No. 15/682,506 filed Aug. 21, 2017 and titled “Room Association Based on Name,” and U.S. Pat. No. 8,483,853 filed Sep. 11, 2007, and titled “Controlling and manipulating groupings in a multi-zone media system.” In some embodiments, the media playback system 100 may not implement Areas, in which case the system may not store variables associated with Areas.

The memory 216 may be further configured to store other data. Such data may pertain to audio sources accessible by a playback device or a playback queue that the playback device (or some other playback device(s)) may be associated with. In embodiments described below, the memory 216 is configured to store a set of command data for selecting a particular VAS, such as the first VAS 160, when processing voice inputs.

During operation, one or more playback zones in the environment of FIG. 1 may each be playing different audio content. For instance, the user may be grilling in the Balcony zone and listening to hip hop music being played by the playback device 102c while another user may be preparing food in the Kitchen zone and listening to classical music being played by the playback device 102i. In another example, a playback zone may play the same audio content in synchrony with another playback zone. For instance, the user may be in the Office zone where the playback device 102d is playing the same hip-hop music that is being playing by playback device 102c in the Balcony zone. In such a case, playback devices 102c and 102d may be playing the hip-hop in synchrony such that the user may seamlessly (or at least substantially seamlessly) enjoy the audio content that is being played out-loud while moving between different playback zones. Synchronization among playback zones may be achieved in a manner similar to that of synchronization among playback devices, as described in U.S. patent Ser. No. 15/721,141, titled “Media Playback System with Voice Assistance, filed Sep. 29, 2017, which is incorporated by reference herein in its entirety.

As suggested above, the zone configurations of the media playback system 100 may be dynamically modified. As such, the media playback system 100 may support numerous configurations. For example, if a user physically moves one or more playback devices to or from a zone, the media playback system 100 may be reconfigured to accommodate the change(s). For instance, if the user physically moves the playback device 102c from the Balcony zone to the Office zone, the Office zone may now include both the playback devices 102c and 102d. In some cases, the use may pair or group the moved playback device 102c with the Office zone and/or rename the players in the Office zone using, e.g., one of the controller devices 104 and/or voice input. As another example, if one or more playback devices 102 are moved to a particular area in the home environment that is not already a playback zone, the moved playback device(s) may be renamed or associated with a playback zone for the particular area.

Further, different playback zones of the media playback system 100 may be dynamically combined into zone groups or split up into individual playback zones. For example, the Dining Room zone and the Kitchen zone may be combined into a zone group for a dinner party such that playback devices 102i and 102l may render audio content in synchrony. As another example, bonded playback devices 102 in the Living Room zone may be split into (i) a television zone and (ii) a separate listening zone. The television zone may include the Front playback device 102b. The listening zone may include the Right, Left, and SUB playback devices 102a, 102j, and 102k, which may be grouped, paired, or merged, as described above. Splitting the Living Room zone in such a manner may allow one user to listen to music in the listening zone in one area of the living room space, and another user to watch the television in another area of the living room space. In a related example, a user may implement either of the NMD 103a or 103b to control the Living Room zone before it is separated into the television zone and the listening zone. Once separated, the listening zone may be controlled, for example, by a user in the vicinity of the NMD 103a, and the television zone may be controlled, for example, by a user in the vicinity of the NMD 103b. As described above, however, any of the NMDs 103 may be configured to control the various playback and other devices of the media playback system 100.

c. Example Controller Devices

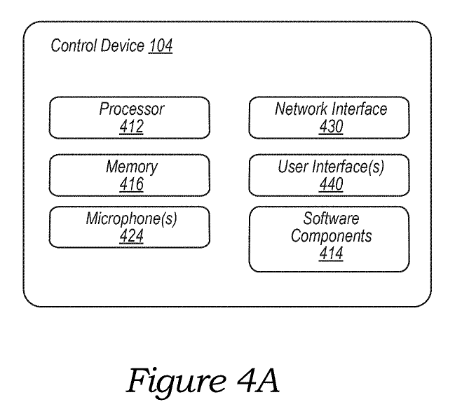

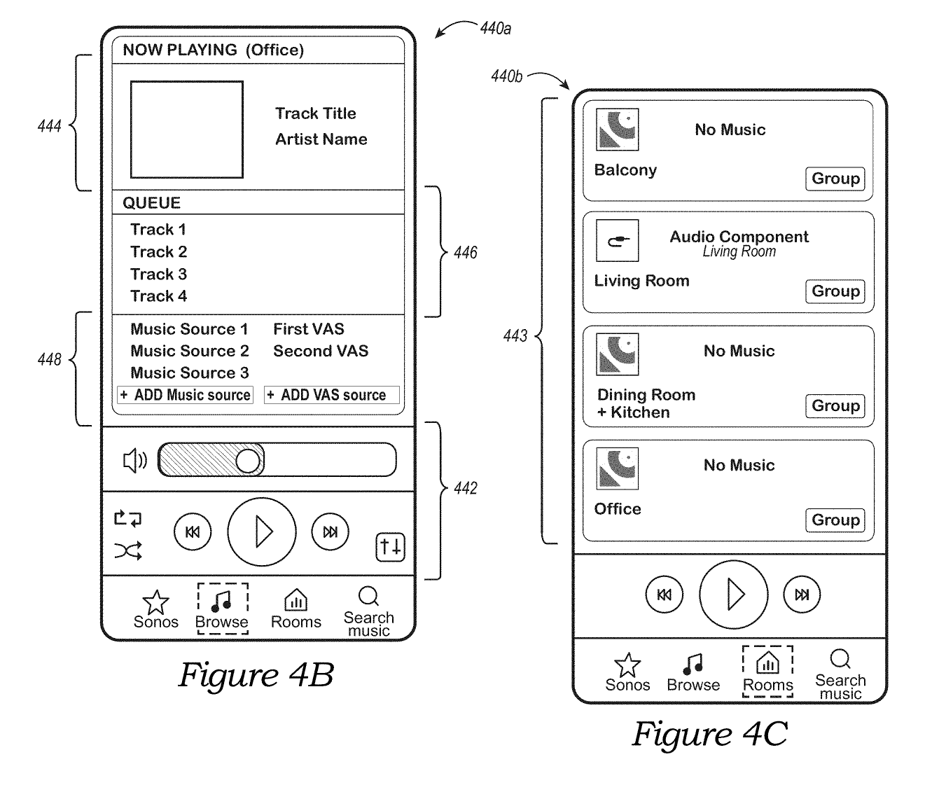

FIG. 4A is a functional block diagram illustrating certain aspects of a selected one of the controller devices 104 of the media playback system 100 of FIG. 1. Such controller devices may also be referred to as a controller. The controller device shown in FIG. 3 may include components that are generally similar to certain components of the network devices described above, such as a processor 412, memory 416, microphone(s) 424, and a network interface 430. In one example, a controller device may be a dedicated controller for the media playback system 100. In another example, a controller device may be a network device on which media playback system controller application software may be installed, such as for example, an iPhone™, iPad™ or any other smart phone, tablet or network device (e.g., a networked computer such as a PC or Mac™)

The memory 416 of a controller device may be configured to store controller application software and other data associated with the media playback system 100 and a user of the system 100. The memory 416 may be loaded with one or more software components 414 executable by the processor 412 to achieve certain functions, such as facilitating user access, control, and configuration of the media playback system 100. A controller device communicates with other network devices over the network interface 430, such as a wireless interface, as described above.

In one example, data and information (e.g., such as a state variable) may be communicated between a controller device and other devices via the network interface 430. For instance, playback zone and zone group configurations in the media playback system 100 may be received by a controller device from a playback device, a network microphone device, or another network device, or transmitted by the controller device to another playback device or network device via the network interface 406. In some cases, the other network device may be another controller device.

Playback device control commands such as volume control and audio playback control may also be communicated from a controller device to a playback device via the network interface 430. As suggested above, changes to configurations of the media playback system 100 may also be performed by a user using the controller device. The configuration changes may include adding/removing one or more playback devices to/from a zone, adding/removing one or more zones to/from a zone group, forming a bonded or merged player, separating one or more playback devices from a bonded or merged player, among others.

The user interface(s) 440 of a controller device may be configured to facilitate user access and control of the media playback system 100, by providing controller interface(s) such as the controller interfaces 440a and 440b shown in FIGS. 4B and 4C, respectively, which may be referred to collectively as the controller interface 440. Referring to FIGS. 4B and 4C together, the controller interface 440 includes a playback control region 442, a playback zone region 443, a playback status region 444, a playback queue region 446, and a sources region 448. The user interface 400 as shown is just one example of a user interface that may be provided on a network device such as the controller device shown in FIG. 3 and accessed by users to control a media playback system such as the media playback system 100. Other user interfaces of varying formats, styles, and interactive sequences may alternatively be implemented on one or more network devices to provide comparable control access to a media playback system.

The playback control region 442 (FIG. 4B) may include selectable (e.g., by way of touch or by using a cursor) icons to cause playback devices in a selected playback zone or zone group to play or pause, fast forward, rewind, skip to next, skip to previous, enter/exit shuffle mode, enter/exit repeat mode, enter/exit cross fade mode. The playback control region 442 may also include selectable icons to modify equalization settings, and playback volume, among other possibilities.

The playback zone region 443 (FIG. 4C) may include representations of playback zones within the media playback system 100. The playback zones regions may also include representation of zone groups, such as the Dining Room+Kitchen zone group, as shown. In some embodiments, the graphical representations of playback zones may be selectable to bring up additional selectable icons to manage or configure the playback zones in the media playback system, such as a creation of bonded zones, creation of zone groups, separation of zone groups, and renaming of zone groups, among other possibilities.

For example, as shown, a “group” icon may be provided within each of the graphical representations of playback zones. The “group” icon provided within a graphical representation of a particular zone may be selectable to bring up options to select one or more other zones in the media playback system to be grouped with the particular zone. Once grouped, playback devices in the zones that have been grouped with the particular zone will be configured to play audio content in synchrony with the playback device(s) in the particular zone. Analogously, a “group” icon may be provided within a graphical representation of a zone group. In this case, the “group” icon may be selectable to bring up options to deselect one or more zones in the zone group to be removed from the zone group. Other interactions and implementations for grouping and ungrouping zones via a user interface such as the user interface 400 are also possible. The representations of playback zones in the playback zone region 443 (FIG. 4C) may be dynamically updated as playback zone or zone group configurations are modified.

The playback status region 444 (FIG. 4B) may include graphical representations of audio content that is presently being played, previously played, or scheduled to play next in the selected playback zone or zone group. The selected playback zone or zone group may be visually distinguished on the user interface, such as within the playback zone region 443 and/or the playback status region 444. The graphical representations may include track title, artist name, album name, album year, track length, and other relevant information that may be useful for the user to know when controlling the media playback system via the user interface 440.

The playback queue region 446 may include graphical representations of audio content in a playback queue associated with the selected playback zone or zone group. In some embodiments, each playback zone or zone group may be associated with a playback queue containing information corresponding to zero or more audio items for playback by the playback zone or zone group. For instance, each audio item in the playback queue may comprise a uniform resource identifier (URI), a uniform resource locator (URL) or some other identifier that may be used by a playback device in the playback zone or zone group to find and/or retrieve the audio item from a local audio content source or a networked audio content source, possibly for playback by the playback device.

In one example, a playlist may be added to a playback queue, in which case information corresponding to each audio item in the playlist may be added to the playback queue. In another example, audio items in a playback queue may be saved as a playlist. In a further example, a playback queue may be empty, or populated but “not in use” when the playback zone or zone group is playing continuously streaming audio content, such as Internet radio that may continue to play until otherwise stopped, rather than discrete audio items that have playback durations. In an alternative embodiment, a playback queue can include Internet radio and/or other streaming audio content items and be “in use” when the playback zone or zone group is playing those items. Other examples are also possible.

When playback zones or zone groups are “grouped” or “ungrouped,” playback queues associated with the affected playback zones or zone groups may be cleared or re-associated. For example, if a first playback zone including a first playback queue is grouped with a second playback zone including a second playback queue, the established zone group may have an associated playback queue that is initially empty, that contains audio items from the first playback queue (such as if the second playback zone was added to the first playback zone), that contains audio items from the second playback queue (such as if the first playback zone was added to the second playback zone), or a combination of audio items from both the first and second playback queues. Subsequently, if the established zone group is ungrouped, the resulting first playback zone may be re-associated with the previous first playback queue, or be associated with a new playback queue that is empty or contains audio items from the playback queue associated with the established zone group before the established zone group was ungrouped. Similarly, the resulting second playback zone may be re-associated with the previous second playback queue, or be associated with a new playback queue that is empty, or contains audio items from the playback queue associated with the established zone group before the established zone group was ungrouped. Other examples are also possible.

With reference still to FIGS. 4B and 4C, the graphical representations of audio content in the playback queue region 446 (FIG. 4C) may include track titles, artist names, track lengths, and other relevant information associated with the audio content in the playback queue. In one example, graphical representations of audio content may be selectable to bring up additional selectable icons to manage and/or manipulate the playback queue and/or audio content represented in the playback queue. For instance, a represented audio content may be removed from the playback queue, moved to a different position within the playback queue, or selected to be played immediately, or after any currently playing audio content, among other possibilities. A playback queue associated with a playback zone or zone group may be stored in a memory on one or more playback devices in the playback zone or zone group, on a playback device that is not in the playback zone or zone group, and/or some other designated device. Playback of such a playback queue may involve one or more playback devices playing back media items of the queue, perhaps in sequential or random order.

The sources region 448 may include graphical representations of selectable audio content sources and selectable voice assistants associated with a corresponding VAS. The VASes may be selectively assigned. In some examples, multiple VASes, such as AMAZON's ALEXA® and another voice service, may be invokable by the same network microphone device. In some embodiments, a user may assign a VAS exclusively to one or more network microphone devices. For example, a user may assign the first VAS 160 to one or both of the NMDs 102a and 102b in the Living Room shown in FIG. 1, and a second VAS to the NMD 103f in the Kitchen. Other examples are possible.

d. Example Audio Content Sources

The audio sources in the sources region 448 may be audio content sources from which audio content may be retrieved and played by the selected playback zone or zone group. One or more playback devices in a zone or zone group may be configured to retrieve for playback audio content (e.g., according to a corresponding URI or URL for the audio content) from a variety of available audio content sources. In one example, audio content may be retrieved by a playback device directly from a corresponding audio content source (e.g., a line-in connection). In another example, audio content may be provided to a playback device over a network via one or more other playback devices or network devices.

Example audio content sources may include a memory of one or more playback devices in a media playback system such as the media playback system 100 of FIG. 1, local music libraries on one or more network devices (such as a controller device, a network-enabled personal computer, or a networked-attached storage (NAS), for example), streaming audio services providing audio content via the Internet (e.g., the cloud), or audio sources connected to the media playback system via a line-in input connection on a playback device or network devise, among other possibilities.

In some embodiments, audio content sources may be regularly added or removed from a media playback system such as the media playback system 100 of FIG. 1. In one example, an indexing of audio items may be performed whenever one or more audio content sources are added, removed or updated. Indexing of audio items may involve scanning for identifiable audio items in all folders/directory shared over a network accessible by playback devices in the media playback system, and generating or updating an audio content database containing metadata (e.g., title, artist, album, track length, among others) and other associated information, such as a URI or URL for each identifiable audio item found. Other examples for managing and maintaining audio content sources may also be possible.

e. Example Network Microphone Devices

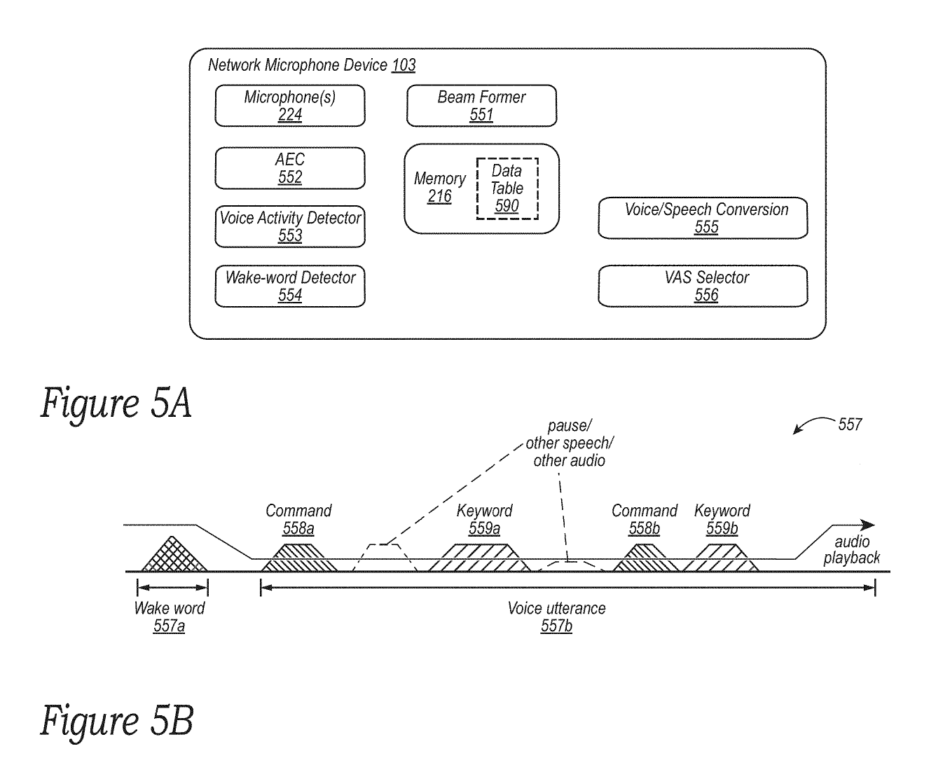

FIG. 5A is a functional block diagram showing additional features of one or more of the NMDs 103 in accordance with aspects of the disclosure. The network microphone device shown in FIG. 5A may include components that are generally similar to certain components of network microphone devices described above, such as the processor 212 (FIG. 1), network interface 230 (FIG. 2A), microphone(s) 224, and the memory 216. Although not shown for purposes of clarity, a network microphone device may include other components, such as speakers, amplifiers, signal processors, as discussed above.

The microphone(s) 224 may be a plurality of microphones arranged to detect sound in the environment of the network microphone device. In one example, the microphone(s) 224 may be arranged to detect audio from one or more directions relative to the network microphone device. The microphone(s) 224 may be sensitive to a portion of a frequency range. In one example, a first subset of the microphone(s) 224 may be sensitive to a first frequency range, while a second subset of the microphone(s) 224 may be sensitive to a second frequency range. The microphone(s) 224 may further be arranged to capture location information of an audio source (e.g., voice, audible sound) and/or to assist in filtering background noise. Notably, in some embodiments the microphone(s) 224 may have a single microphone rather than a plurality of microphones.

A network microphone device may further include beam former components 551, acoustic echo cancellation (AEC) components 552, voice activity detector components 553, wake word detector components 554, speech/text conversion components 555 (e.g., voice-to-text and text-to-voice), and VAS selector components 556. In various embodiments, one or more of the components 551-556 may be a subcomponent of the processor 512.

The beamforming and AEC components 551 and 552 are configured to detect an audio signal and determine aspects of voice input within the detect audio, such as the direction, amplitude, frequency spectrum, etc. For example, the beamforming and AEC components 551 and 552 may be used in a process to determine an approximate distance between a network microphone device and a user speaking to the network microphone device. In another example, a network microphone device may detective a relative proximity of a user to another network microphone device in a media playback system.

The voice activity detector activity components 553 are configured to work closely with the beamforming and AEC components 551 and 552 to capture sound from directions where voice activity is detected. Potential speech directions can be identified by monitoring metrics which distinguish speech from other sounds. Such metrics can include, for example, energy within the speech band relative to background noise and entropy within the speech band, which is measure of spectral structure. Speech typically has a lower entropy than most common background noise.

The wake-word detector components 554 are configured to monitor and analyze received audio to determine if any wake words are present in the audio. The wake-word detector components 554 may analyze the received audio using a wake word detection algorithm. If the wake-word detector 554 detects a wake word, a network microphone device may process voice input contained in the received audio. Example wake word detection algorithms accept audio as input and provide an indication of whether a wake word is present in the audio. Many first- and third-party wake word detection algorithms are known and commercially available. For instance, operators of a voice service may make their algorithm available for use in third-party devices. Alternatively, an algorithm may be trained to detect certain wake-words.

In some embodiments, the wake-word detector 554 runs multiple wake word detections algorithms on the received audio simultaneously (or substantially simultaneously). As noted above, different voice services (e.g. AMAZON's ALEXA®, APPLE's SIRI®, or MICROSOFT's CORTANA®) each use a different wake word for invoking their respective voice service. To support multiple services, the wake word detector 554 may run the received audio through the wake word detection algorithm for each supported voice service in parallel.

The VAS selector components 556 are configured to detect for commands spoken by the user within a voice input. The speech/text conversion components 555 may facilitate processing by converting speech in the voice input to text. In some embodiments, a network microphone device may include voice recognition software that is trained to a particular user or a particular set of users associated with a household. Such voice recognition software may implement voice-processing algorithms that are tuned to specific voice profile(s). Tuning to specific voice profiles may require less computationally intensive algorithms than traditional VASes, which typically sample from a broad base of users and diverse requests that are not targeted to media playback systems.

The VAS selector components 556 are also configured to determine if certain command criteria are met for particular command(s) detected in a voice input. Command criteria for a given command in a voice input may be based, for example, on the inclusion of certain keywords within the voice input. A keyword may be, for example, a word in the voice input identifying a particular device or group in the media playback system 100. As used herein, the term “keyword” may refer to a single word (e.g., “Bedroom”) or a group of words (e.g., “the Living Room”).

In addition or alternately, command criteria for given command(s) may involve detection of one or more control state and/or zone state variables in conjunction with detecting the given command(s). Control state variables may include, for example, indicators identifying a level of volume, a queue associated with one or more device(s), and playback state, such as whether devices are playing a queue, paused, etc. Zone state variables may include, for example, indicators identifying which, if any, zone players are grouped. The VAS selector components 556 may store in the memory 216 a set of command information, such as in a data table 590, that contains a listing of commands and associated command criteria, which are described in greater detail below.

In some embodiments, one or more of the components 551-556 described above can operate in conjunction with the microphone(s) 224 to detect and store a user's voice profile, which may be associated with a user account of the media playback system 100. In some embodiments, voice profiles may be stored as and/or compared to variables stored in the set of command information 590, as described below. The voice profile may include aspects of the tone or frequency of user's voice and/or other unique aspects of the user such as those described in U.S. patent Ser. No. 15/721,141, titled “Media Playback System with Voice Assistance, filed Sep. 29, 2017, which is incorporated by reference herein in its entirety.

In some embodiments, one or more of the components 551-556 described above can operate in conjunction with the microphone array 524 to determine the location of a user in the home environment and/or relative to a location of one or more of the NMDs 103. The location or proximity of a user may be detected and compared to a variable stored in the command information 590, as described below. Techniques for determining the location or proximity of a user may include one or more techniques disclosed in U.S. patent Ser. No. 15/721,141, titled “Media Playback System with Voice Assistance, filed Sep. 29, 2017, which is incorporated by reference herein in its entirety.

FIG. 5B is a diagram of an example voice input in accordance with aspects of the disclosure. The voice input may be captured by a network microphone device, such as by one or more of the NMDs 103 shown in FIG. 1. The voice input may include a wake word portion 557a and a voice utterance portion 557b (collectively “voice input 557”). In some embodiments, the wake word 557a can be a known wake word, such as “Alexa,” which is associated with AMAZON's ALEXA®). In other embodiments, the voice input 557 may not include a wake word.

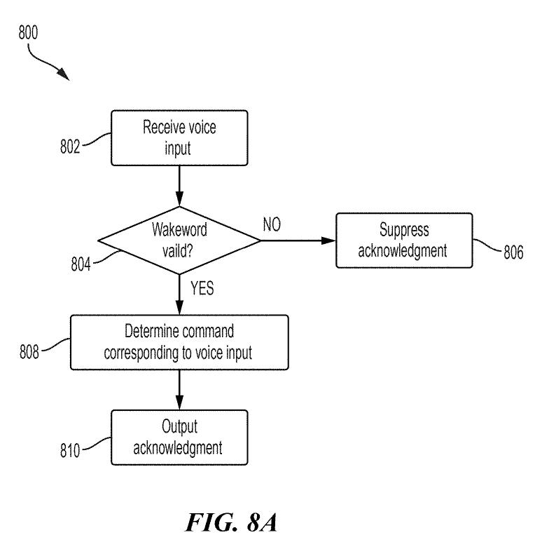

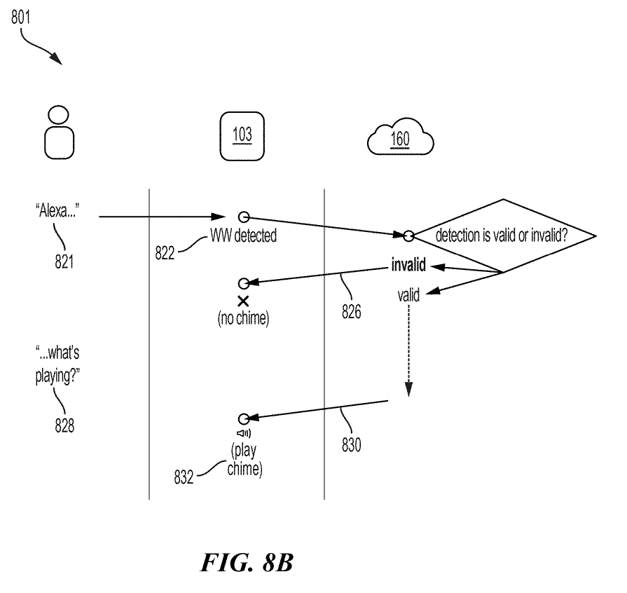

In some embodiments, a network microphone device may output an audible and/or visible response or feedback element upon detection of the wake word portion 557a. In addition or alternately, a network microphone device may output an audible and/or visible response after processing a voice input and/or a series of voice inputs (e.g., in the case of a multi-turn request). Additional details regarding the use of feedback elements are discussed below with references to FIGS. 8A-12D.

The voice utterance portion 557b may include, for example, one or more spoken commands 558 (identified individually as a first command 558a and a second command 558b) and one or more spoken keywords 559 (identified individually as a first keyword 559a and a second keyword 559b). In one example, the first command 557a can be a command to play music, such as a specific song, album, playlist, etc. In this example, the keywords 559 may be one or words identifying one or more zones in which the music is to be played, such as the Living Room and the Dining Room shown in FIG. 1. In some examples, the voice utterance portion 557b can include other information, such as detected pauses (e.g., periods of non-speech) between words spoken by a user, as shown in FIG. 5B. The pauses may demarcate the locations of separate commands, keywords, or other information spoke by the user within the voice utterance portion 557b.

In some embodiments, the media playback system 100 is configured to temporarily reduce the volume of audio content that it is playing while detecting the wake word portion 557a. The media playback system 100 may restore the volume after processing the voice input 557, as shown in FIG. 5B. Such a process can be referred to as ducking, examples of which are disclosed in U.S. patent Ser. No. 15/721,141, titled “Media Playback System with Voice Assistance, filed Sep. 29, 2017, which is incorporated by reference herein in its entirety.

f. Example Network and Remote Computing Systems

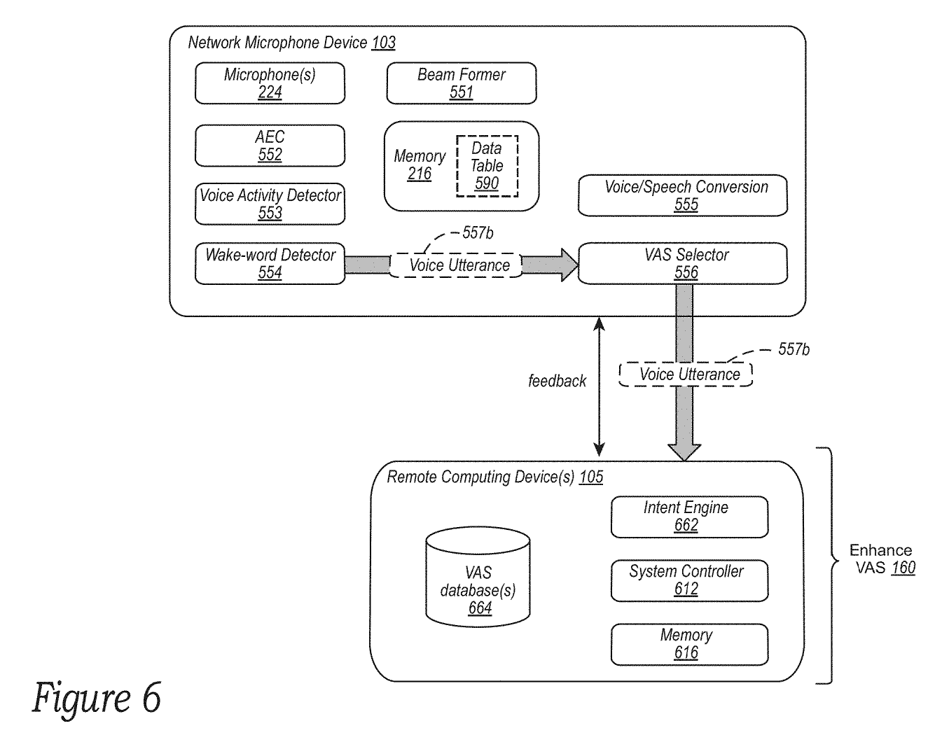

FIG. 6 is a functional block diagram showing additional details of the remote computing device(s) 105 in FIG. 1. In various embodiments, the remote computing device(s) 105 may receive voice inputs from one or more of the NMDs 103 over the WAN 107 shown in FIG. 1. For purposes of illustration, selected communication paths of the voice input 557 (FIG. 5B) are represented by arrows in FIG. 6. In one embodiment, the voice input 557 processed by the remote computing device(s) 105 may include the voice utterance portion 557b (FIG. 5B). In another embodiment, the processed voice input 557 may include both the voice utterance portion 557b and the wake word 557a (FIG. 5B)

The remote computing device(s) 105 includes a system controller 612 comprising one or more processors, an intent engine 602, and a memory 616. The memory 616 may be a tangible computer-readable medium configured to store instructions executable by the system controller 612 and/or one or more of the playback, network microphone, and/or controller devices 102-104.

The intent engine 662 is configured to process a voice input and determine an intent of the input. In some embodiments, the intent engine 662 may be a subcomponent of the system controller 612. The intent engine 662 may interact with one or more database(s), such as one or more VAS database(s) 664, to process voice inputs. The VAS database(s) 664 may reside in the memory 616 or elsewhere, such as in memory of one or more of the playback, network microphone, and/or controller devices 102-104. In some embodiments, the VAS database(s) 664 may be updated for adaptive learning and feedback based on the voice input processing. The VAS database(s) 664 may store various user data, analytics, catalogs, and other information for NLU-related and/or other processing.

The remote computing device(s) 105 may exchange various feedback, information, instructions, and/or related data with the various playback, network microphone, and/or controller devices 102-104 of the media playback system 100. Such exchanges may be related to or independent of transmitted messages containing voice inputs. In some embodiments, the remote computing device(s) 105 and the media playback system 100 may exchange data via communication paths as described herein and/or using a metadata exchange channel as described in U.S. patent Ser. No. 15/721,141, titled “Media Playback System with Voice Assistance, filed Sep. 29, 2017, which is incorporated by reference herein in its entirety.

Processing of a voice input by devices of the media playback system 100 may be carried out at least partially in parallel with processing of the voice input by the remote computing device(s) 105. Additionally, the speech/text conversion components 555 of a network microphone device may convert responses from the remote computing device(s) 105 to speech for audible output via one or more speakers.

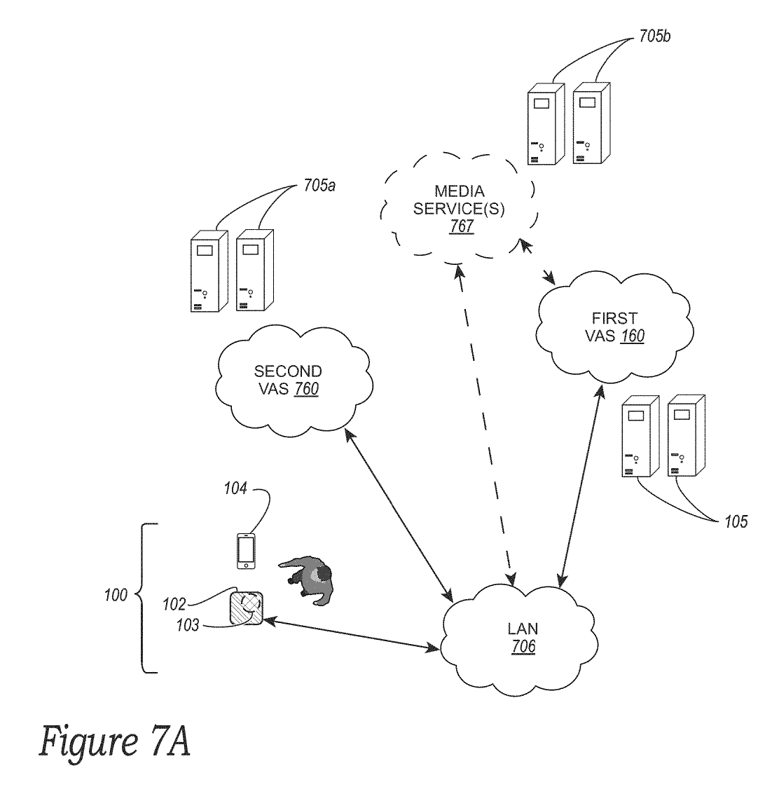

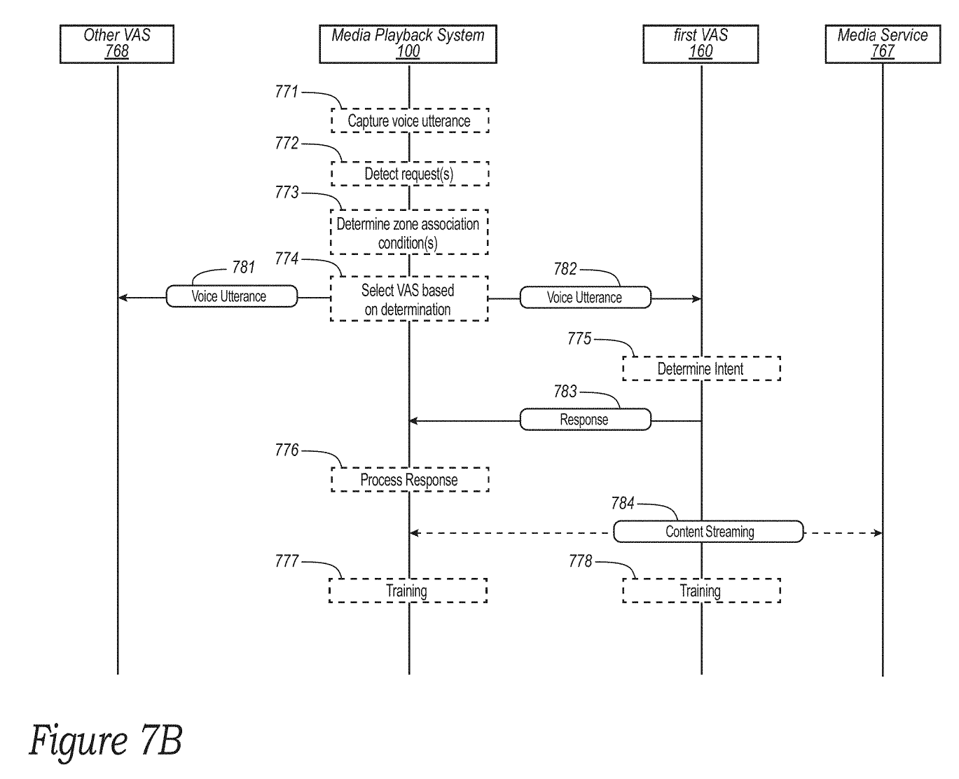

In accordance with various embodiments of the present disclosure, the remote computing device(s) 105 carry out functions of the first VAS 160 for the media playback system 100. FIG. 7A is schematic diagram of an example network system 700 that comprises the first VAS 160. As shown, the remote computing device(s) 105 are coupled to the media playback system 100 via the WAN 107 (FIG. 1) and/or a LAN 706 connected to the WAN 107. In this way, the various playback, network microphone, and controller devices 102-104 of the media playback system 100 may communicate with the remote computing device(s) 105 to invoke functions of the first VAS 160.

The network system 700 further includes additional first remote computing device(s) 705a (e.g., cloud servers) and second remote computing device(s) 705b (e.g., cloud servers). The second remote computing device(s) 705b may be associated with a media service provider 767, such as SPOTIFY® or PANDORA®. In some embodiments, the second remote computing device(s) 705b may communicate directly the computing device(s) of the first VAS 160. In addition or alternately, the second remote computing device(s) 705b may communicate with the media playback system 100 and/or other intervening remote computing device(s).

The first remote computing device(s) 705a may be associated with a second VAS 760. The second VAS 760 may be a traditional VAS provider associated with, e.g., AMAZON's ALEXA®, APPLE's SIRI®, MICROSOFT's CORTANA®, or another VAS provider. Although not shown for purposes of clarity, the network computing system 700 may further include remote computing devices associated with one or more additional VASes, such as additional traditional VASes. In such embodiments, media playback system 100 may be configured to select the first VAS 160 over the second VAS 760 as well as another VAS.

FIG. 7B is a message flow diagram illustrating various data exchanges in the network computing system 700 of FIG. 7A. The media playback system 100 captures a voice input via a network microphone device (block 771), such as via one or more of the NMDs 103 shown in FIG. 1. The media playback system 100 may select an appropriate VAS based on commands and associated command criteria in the set of command information 590 (blocks 771-774), as described below. If the second VAS 760 is selected, the media playback system 100 may transmit one or messages 781 (e.g., packets) containing the voice input to the second VAS 760 for processing.

If, on the other hand, the first VAS 160 is selected, the media playback system 100 transmits one or more messages 782 (e.g., packets) containing the voice input to the VAS 160. The media playback system 100 may concurrently transmit other information to the VAS 160 with the message(s) 782. For example, the media playback system 100 may transmit data over a metadata channel

The first VAS 160 may process the voice input in the message(s) 782 to determine intent (block 775). Based on the intent, the VAS 160 may send one or more response messages 783 (e.g., packets) to the media playback system 100. In some instances, the response message(s) 783 may include a payload that directs one or more of the devices of the media playback system 100 to execute instructions (block 776). For example, the instructions may direct the media playback system 100 to play back media content, group devices, and/or perform other functions described below. In addition or alternately, the response message(s) 783 from the VAS 160 may include a payload with a request for more information, such as in the case of multi-turn commands.

In some embodiments, the response message(s) 783 sent from the first VAS 160 may direct the media playback system 100 to request media content, such as audio content, from the media service(s) 667. In other embodiments, the media playback system 100 may request content independently from the VAS 160. In either case, the media playback system 100 may exchange messages for receiving content, such as via a media stream 784 comprising, e.g., audio content.

In some embodiments, the media playback system 100 may receive audio content from a line-in interface on a playback, network microphone, or other device over a local area network via a network interface. Example audio content includes one or more audio tracks, a talk show, a film, a television show, a podcast, an Internet streaming video, among many possible other forms of audio content. The audio content may be accompanied by video (e.g., an audio track of a video) or the audio content may be content that is unaccompanied by video.

In some embodiments, the media playback system 100 and/or the first VAS 160 may use voice inputs that result in successful (or unsuccessful) responses from the VAS for training and adaptive training and learning (blocks 777 and 778). Training and adaptive learning may enhance the accuracy of voice processing by the media playback system 100 and or the first VAS 160. In one example, the intent engine 662 (FIG. 6) may update and maintain training learning data in the VAS database(s) 664 for one or more user accounts associated with the media playback system 100.

### III. EXAMPLE METHOD AND SYSTEM FOR INVOKING A VAS

FIG. 8A is a flow diagram of a process 800 configured to receive voice input in accordance with aspects of the disclosed technology. In some embodiments, the process 800 comprises one or more instructions stored in memory (e.g., the memory 216 of FIG. 2A) and executed by one or more processors (e.g., the processor 212 of FIG. 2A) of an NMD (e.g., the NMD 103 of FIGS. 2A and 6) and/or a playback device (e.g., the playback device 102 of FIG. 2A) of a media playback system (e.g., the media playback system 100 of FIG. 1). In certain embodiments, the process 800 comprises instructions stored on memory (e.g., the memory 616 of FIG. 6) stored on a computing device(s) (e.g., the remote computing device(s) 105 of FIG. 6) remote from a media playback system.

At block 802, the process 800 receives voice input from a user via one or microphones (e.g., the microphones 224 of FIG. 2A) as described above, for example, with respect to FIG. 5B.

At block 804, the process 800 determines whether the voice input received at block 802 includes a valid wake word. As described above, valid wake words can include, for example, “Alexa,” “Ok, Google,” “Hey, Siri,” “Hey, Sonos,” etc. In some embodiments, an NMD (e.g., the NMD 103 of FIGS. 2A and 6) performs wake word detection and determines whether the received voice input includes a valid wake word. In some embodiments, the wake word detection and validity determination is performed on a remote computing device (e.g., the remote computing device(s) 105 of FIG. 6). In certain embodiments, the NMD performs a “first-pass” wake word detection and the remote computing device confirms whether a wake word is indeed present in the received voice input after the “first-pass” determination.

In some embodiments, for example, the remote computing device(s) can receive the voice input data via an NMD (as shown, for example, in FIG. 6) and determine whether a voice utterance in the voice input data comprises a valid wake word. If the voice input data includes a valid wake word, the remote computing device can transmit a corresponding message to the NMD indicating the valid wake word. If, however, the voice input lacks a detected valid wake word, the remote computing device can transmit a message to the NMD indicating the absence of a valid wake word. In certain embodiments, the message to the NMD indicating the absence of a valid wake word accompanies and/or replaces a “stop capture” message transmitted from the remote computing device to the NMD. In other embodiments, the remote computing device may not transmit a message at all.

If the process 800 fails to detect a valid wake word in the received voice data, the process 800 proceeds to block 806 and suppresses a feedback element. As described above, for example, with respect to FIG. 6, the NMD can be configured to cause to output a feedback element (e.g., an audible and/or visible response) after processing a voice input and/or a series of voice inputs. The feedback element can include, for example, a chime or other sound, a flashing light (e.g., an LED on the NMD), a text-to-speech (TTS) output, and/or another output at the NMD and/or another device in the media playback system. If a valid wake word is not detected, the process 800 suppresses or other otherwise prevents output of a feedback element. Suppression of a feedback element in the absence of a detection of a valid wake word can provide a benefit of alerting the user that the NMD or the VAS has not detected a valid wake word and that any command in the voice input data was not received. In some instances, the user may have used a proper wake word for a first VAS (e.g., Amazon Alexa), while the media playback system employs a second VAS (e.g., Google). The process 800 can, at block 806, provide an indication that a wake word for detected for the first VAS and can further alert the user that a wake word for the second VAS should be used instead.

If the process 800 detects a valid wake word, the process 800 proceeds to block 808 and determines one or more commands corresponding and/or included in the received voice input. As described above, the determination can include determining, via the NMD, another device on the media playback system, and/or the remote computing device, the presence of one or more command requests in the voice input data. In some embodiments, for example, the remote computing device can send a message to the NMD indicating an action to be performed that corresponds to the command request. Moreover, in the illustrated embodiment of FIG. 8A, the process 800 determines a presence of a valid wake word and a command request in separate steps. In other embodiments, however, determination of a valid wake word and command request occurs at the same step. For instance, the process 800 can receive a voice utterance comprising a wake word and a command request. The process 800 can transmit the voice utterance to the remote computing device (e.g., a cloud server) of a VAS and receive a message indicating that the voice utterance includes a wake word and further indicating an action to be performed by the process 800. In some embodiments, the message comprises an instruction to stop capture of voice input in response to detection of a valid wake word and/or a lack of a valid wake word

At block 810, the process 800 outputs a feedback element (e.g., a chime, a flashing light, a TTS response) in response to receiving the voice input with valid wake word and a command request. In some embodiments, for example, the process 800 delays output of the feedback element and outputs the feedback element after receiving the valid wake word and the command request. Some conventional voice assistants output a feedback element immediately upon detection of the wake word, before receiving, detecting and/or determining of an accompanying command request. However, outputting the feedback element after receiving the command request can provide a more effective acknowledgement of command receipt and a more effective indication of a beginning of processing for action compared to conventional approaches. Moreover, the disclosed technology may provide additional benefits of avoiding interrupting listeners who do not pause for acknowledgement after speaking the wake word, and/or avoiding teaching new listeners to pause unnaturally.

FIG. 8B is a functional flow diagram of an example process 801 of receiving voice input. As shown, for example, in FIG. 8B, the process 801 can include receiving a voice utterance 821 comprising a wake word (e.g., “Alexa”). The process 801 can detect a wake word 822 and determine whether the detected wake word 822 is valid. If the detected wake word 822 is determined to be invalid, the process 800 can receive a message 826 indicating an absence of a valid wake word and can correspondingly suppress or otherwise prevent output of a feedback element (e.g., a chime). If the detected wake word 822 is determined to be valid, the process 800 can receive a message 830 indicating a presence of a valid wake word and output a corresponding feedback element 832 (e.g., a chime) after receiving a command request 828 (e.g., “What's playing?).

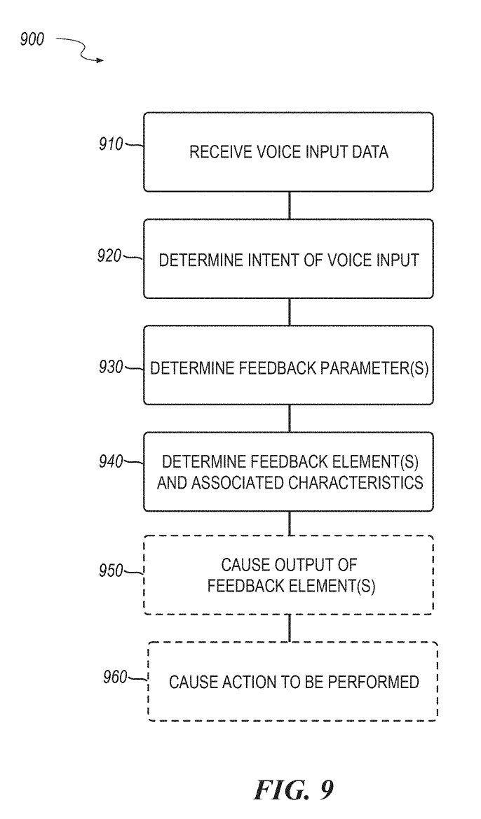

FIG. 9 is a flow diagram of a process 900 configured to determine a feedback element and associated characteristics in accordance with aspects of the disclosed technology. In some embodiments, for example, the process 900 comprises one or more instructions stored in memory (e.g., the memory 216 of FIG. 2A) and executed by one or more processors (e.g., the processor 212 of FIG. 2A) of an NMD (e.g., the NMD 103 of FIGS. 2A and 6) and/or a playback device (e.g., the playback device 102 of FIG. 2A) of a media playback system (e.g., the media playback system 100 of FIG. 1). In certain embodiments, the process 900 comprises instructions stored on memory (e.g., the memory 616 of FIG. 6) stored on a computing device(s) (e.g., the remote computing device(s) 105 of FIG. 6) remote from a media playback system.

At block 910, the process 900 receives voice input data from a user via one or microphones (e.g., the microphones 224 of FIG. 2A) as described above, for example, with respect to FIG. 5B. At block 920, the process 900 may then determine the intent of the voice input as described above, for example, with respect to FIGS. 6 and 7. In some embodiments, the process 900 communicates with one or more VAS's (such as first VAS 160 and second VAS 760) to determine the intent of the voice input.

Also at block 920, the process 900 may determine a command associated with the voice input and whether the command is content-related or content-independent. “Content-related commands” refer to commands that may be performed on played back media content, such as music, podcasts, audio books, video, audio associated with video output, and/or other media content. For instance, the process 900 may receive a content-related command such as a command (e.g., a voice command) to pause media content being played back by a playback device, and/or a command to increase or decrease a volume of the media content being played back by a playback device. Other content-related commands can include, for example, “increase/decrease volume,” “play next,” “play previous,” “resume,” “stop,” “pause,” “group” (with one or more other play back devices), “transfer” (play back of a media item to a different playback device), and others. In contrast, “content-independent commands” refer to commands unrelated or only loosely related to content being played back by a playback device. For instance, if a podcast is being played back via a playback device, the process 900 may receive a content-independent command such as a command to add an item to the user's shopping list or a request for an answer to a question.

The process 900 may determine the command and/or type of command at the same time as or after determining the intent of the voice input. For example, the process 900 may determine the intent of the voice input is to play a particular song, and simultaneously identify the command as “play” and the command type as content-related. In other embodiments, the process 900 may first determine the intent of the voice input, and subsequently determine the command and/or command type. Likewise, the process 900 may determine the command type at the same time as or after determining the command.

At block 930, the process 900 determines one or more parameters derived from the voice input data and/or data related to the listening environment. The process 900 may receive voice input data, media content data, and/or data related to the listening environment (such as secondary data) from a single playback device or from multiple playback devices of the media playback system. As described in greater detail below, the process 900 utilizes the parameters determined at block 930 to tailor the feedback provided to the user at block 950. When a user makes a voice request to an NMD (such as one or more of NMD's 103a-103g in FIG. 1), it may be beneficial to provide feedback to the user to acknowledge the request was received and, should there be any latency, communicate to the user that the request is being processed. Some conventional voice assistants (and/or associated playback devices) output one or more feedback elements without considering the intent of the request and/or the environment in which the request was made. For example, in a home theater environment, the audio being played back is often associated with a television show or movie, and certain types of feedback are disruptive and make it difficult for the user to hear dialogue. As used herein, a “home theater environment” refers to any environment in which the playback device receiving the voice input is in direct communication with, or grouped or bonded with a playback device that is in direct communication with, a visual output device, such as a television, a projector, a computer monitor, etc. Audio feedback may be similarly disruptive for certain types of media content where the audio content is the primary experience (“lean in audio”), such as audiobooks and podcasts. In contrast to the home theater environment, feedback is generally welcome while the user streams music (such as via playback device 102i in FIG. 1). This is also true for types of media content where the audio content is the secondary experience (“lean back” audio), such as audio content associated with sports videos or sports television, music videos, etc.

To address the aforementioned shortcomings of conventional systems, the disclosed technology determines one or more feedback parameters derived from the voice input data, media content data, and/or data related to the listening environment (such as secondary data) and, based on those parameters, selects the feedback element(s) and/or tailors the characteristics of the selected feedback element(s). Such parameters include, for example, the type of command, the type of media content, the input interface over which the audio content is received, the grouping and/or location (relative to the user, environment, or other playback devices) of the NMD receiving the voice input, the volume at which the media content is being played back (if the voice input is received while media content is being played back), the amount of background noise, and a particular user profile.

In some embodiments, the process 900 may determine a type of media content being rendered or played back via at least one playback device in the vicinity of the user from which the voice input data was received at block 910. Types of media content can include, for example, music, podcasts, audiobooks, video, audio associated with video output, and others. In some embodiments, the process 900 is further configured to determine a sub-type of media content. For instance, the process 900 can be configured to determine that the media content being consumed by the user comprises a predetermined subtype (e.g., TV or movie genre such as comedy, drama, a sporting event, and/or cooking; music genre; language, etc.). In other embodiments, however, the process 900 proceeds to block 940 without performing a determination of a media content type and/or subtype.

In some embodiments, the process 900 may determine the input interface over which the audio content is received. The process 900 may determine the input interface based on the media content determination, direct association of the NMD receiving the request with the input interface, and/or indirect association of the NMD receiving the request (e.g., by the group in which the NMD receiving the request belongs). For instance, the process 900 may determine that the user is listening to audio output associated with a television show or movie, and thus determine that the user is listening to a playback device (e.g., the playback device 102b) associated with a television. Likewise, the process 900 may determine that the NMD receiving the request is in communication (wired or wirelessly) with a television, and thus determine that the user is listening to media content input to the media playback system by a television. In some aspects of the technology, the process 900 may determine that the group in which the NMD receiving the request belongs is indicative of a home theater environment, such as a group named “home theater,” “TV room,” “surround sound,” etc. In some embodiments, the process 900 is configured to disambiguate among several playback devices playing back media items and determine which playback device (if any) is rendering media content related to the user's request received at block 910. In other embodiments, however, the process 900 proceeds to block 940 without determining the input interface over which the audio content is received.

In some embodiments, the process 900 may determine a particular user and/or user profile and determine the feedback element(s) and associated characteristics based in part on the identified user and/or user profile. Different users may have different levels of familiarity with voice-enabled technology, and thus certain users require less feedback than others. For instance, the process 900 may identify a particular user based on the user's voice profile and assign a value to a particular user's familiarity with the media playback system (such as media playback system 100) based on the number of requests made by the particular user. In other embodiments, however, the process 900 proceeds to block 940 without performing a determination of a user.

The process 900 may determine one or more of the foregoing parameters at the same time or at different times. For instance, the process 900 may determine the media content type (and/or subtype), user, and/or input interface while or after receiving the wakeword (such as wakeword 557a) but before receiving the command (such as command 558a), and determine the media content type (and/or subtype), user, input interface, or command type while or after receiving the wakeword (such as wakeword 557a).

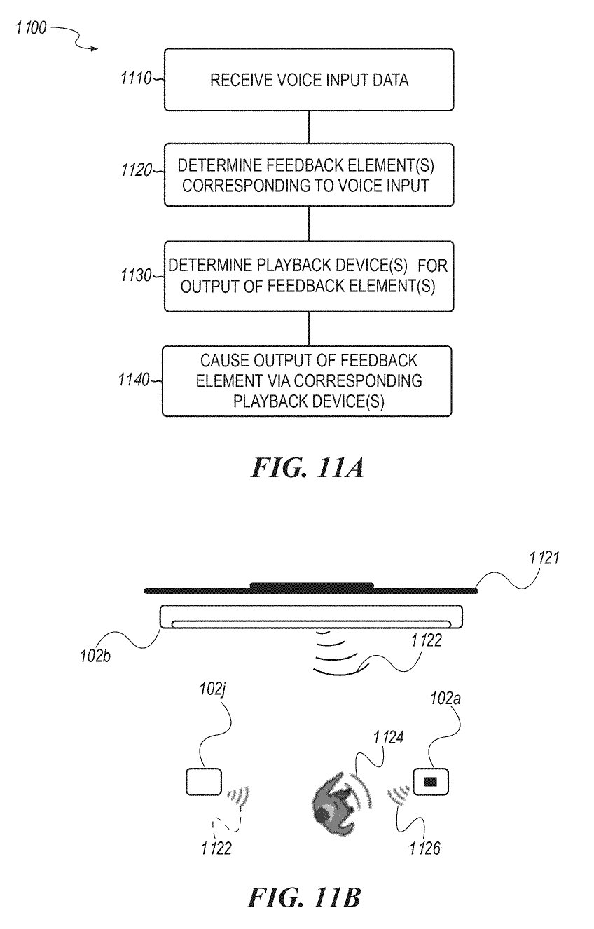

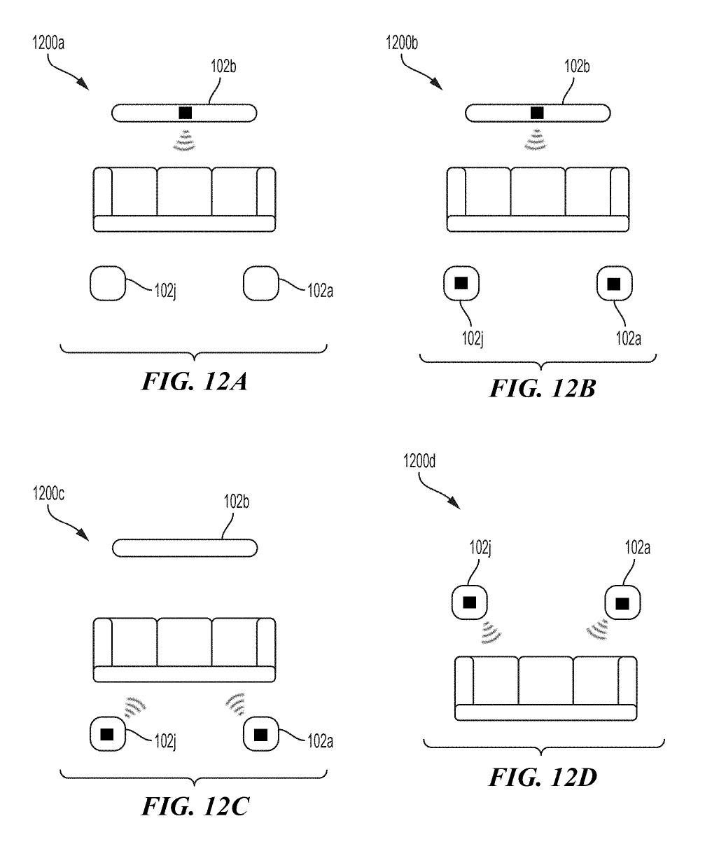

At block 940, based on the determined parameters, the process 900 determines one or more audio or visual feedback elements and associated characteristics. For instance, based on the determined parameters, the process 900 may output an audio feedback element that has a verbal component (e.g., TTS). Additionally or alternatively, the process 900 may output an audio feedback element that does not include a verbal component (e.g., a chime). The process 900 may also determine one or more characteristics of the audio feedback based on the determined parameters. For example, for verbal audio feedback, the process 900 may determine whether to use such feedback, the timing of such feedback (relative to the wakeword, utterance, and/or the process's corresponding response and/or action), and/or a volume level of the verbal audio feedback element(s). For non-verbal audio feedback, the process 900 can determine whether to use such feedback, the timing of such feedback (relative to the wakeword, utterance, and/or the process's corresponding response and/or action), and a volume level of the non-verbal audio feedback element. For visual feedback, the process 900 may determine the intensity, color, and form (e.g., pattern, shape, characters, message etc.) of such feedback, and/or the timing of the visual feedback element (e.g., relative to the wakeword, utterance, and/or the process's corresponding response and/or action). The process 900 may also select a particular playback device(s) for outputting the feedback and/or a volume adjustment of the media content being played back when the request is made, as described in greater detail below with respect to FIGS. 11A-11B and FIGS. 12A-12D.

At block 950, the process 900 causes the feedback element(s) determined at block 940 to be output and/or performed based on one or more of the parameters determined at block 930.

In some embodiments, the process 900 causes a feedback element to be output at the playback device at which a voice command was received and/or a different playback device. In some embodiments, the process 900 determines a feedback element in response to audio content received on an associated playback device (e.g., “in the same room as NMD”, “in the same device as NMD”, “on device associated with NMD”, etc.) over a video interface (e.g., HDMI, TOSlink, etc.). For instance, the process 900 may receive a command to “change the channel” at a first playback device (e.g., the NMD 103 of FIGS. 2A and 6) and correspondingly change a television channel on a different playback device (e.g., a television). The process 900 can, for example, provide an audio feedback element at the first playback device, an audio feedback element at a second playback device (e.g., a playbar coupled to the television), and/or an audio and/or visual feedback element via the television. Or the process 900 may not provide a feedback element since feedback is reflected in the channel change.

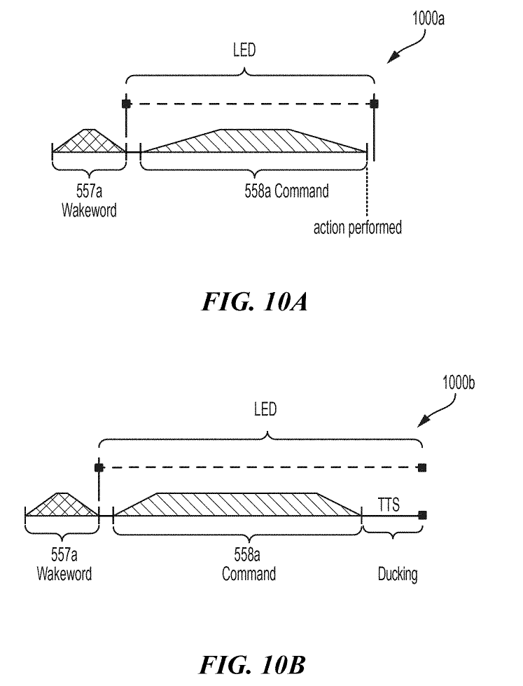

FIGS. 10A and 10B are schematic diagrams illustrating examples of feedback elements determined and output by the process 900. FIG. 10A, for example, represents voice input (wakeword 557a and command 558a) received by the process 900 (such as via NMD 102b in FIG. 1) in a home theater environment 1000a. The process 900 may determine one or more parameters indicative of a home theater environment, which may include determining that the input interface is a television, that the media content being played back is related to a video, that the NMD is in communication with a television, and/or that the NMD is within a group indicative of a home theater environment. As shown in FIG. 10A, the process may determine the parameters indicative of a home theater environment during or after receipt of the wakeword 557a, but before receiving the command 558a. So as not to disrupt the user's listening experience within the home theater environment, the process 900 does not output any audio feedback elements throughout the entirety of receiving the voice input and performing the action. Instead, to acknowledge that the voice-assistant is listening without causing an audible disruption, the process 900 causes a visual feedback element (e.g., an LED) to be displayed after the wakeword until the action is performed (or right after the action is performed). In some embodiments, the process 900 causes the visual feedback element to be displayed only during the command 558b and not when the action is performed.

In some embodiments, the process 900 may determine to use only visual (and not audio) feedback elements based on type of media content, and regardless of any parameters indicative of audio content related to a television show or a movie. For example, the process 900 may determine to provide only visual feedback elements in response a determination that the type of media content is an audiobook, a podcast, or other audio content where the audio content is the primary experience (e.g., lean in audio). Likewise, in some aspects of the disclosure, the process 900 may determine to provide an audio feedback element(s) based on the determined media content type and despite a determination of parameters indicative of a home theater environment. For example, the process 900 may determine the type of media is audio related to television or other video input, and further determine that the sub-type of media content is sports videos, music videos, or other types or sub-types of media content where the audio content is the secondary experience (and where users generally welcome audio feedback) (e.g., lean back audio). In such a scenario, the process 900 may determine to provide one or more audio feedback elements.

In some aspects of the technology, the process 900 may determine the feedback element(s) to output (if any) during and/or after receipt of the command 558a based on any of the parameters or combination of parameters described herein, or based solely on the determined command and/or determined type of command. For example, based on the command 558a and/or command type, the process 900 may cause the action to be performed with or without a feedback element (as shown in FIG. 10A). For instance, the process 900 may determine that a received voice input includes a content-related command (e.g., “pause”) and cause the action to be performed to the played back audio content without an audio feedback element (verbal or non-verbal) for at least the reason that the action (i.e., pausing the audio content) can serve as a feedback element without any further feedback elements corresponding to the command. The inventors have recognized, for example, that not all voice utterances require an equivalent response from the process 900. One benefit of responding to certain types of commands (e.g., content-related commands) without a feedback element is less of a distraction for the user by the voice assistant. Content-related commands (e.g., volume up/down, skip/back, pause/stop, snooze) can be reflected directly in the audio content. In contrast, content-independent commands (e.g., “add [item to shopping list,” “what is the weather?” “what time is it?” etc.) may correspond to a feedback element that includes, for example, an audio or visual indicator.

FIG. 10B represents voice input (wakeword 557a and command 558a) received by the process 900 (such as via NMD 102b in FIG. 1) and associated feedback element(s) in an environment 1000b in which the media content being played back is not indicative of a home theater environment and/or contains a type of media content with audio that is lean back audio (e.g., sports videos, music videos, general music streaming, etc.). In such embodiments, the process 900 may provide one or more audio feedback elements based on the type of command and/or the type of media content (and/or sub-type). For instance, the process 900 may receive a command to add an item to a shopping list. If the process 900 determines that the media content type is music, the process 900 may determine that the feedback element is a TTS response indicating that “the item was added to the shopping list.”

In some aspects of the technology, and as shown in FIG. 10B, the process 900 may cause the volume of the audio being played back to decrease during output of the audio feedback element, then cause the volume to increase to its original output level at the conclusion of output of the audio feedback element (also known as “ducking”). In some aspects of the technology, the process 900 may additionally or alternatively cause ducking to occur during all or a portion of the voice input. For example, the process 900 may cause ducking to occur during receipt of the wakeword 557a and/or during receipt of the command 558a. In other embodiments, the process 900 may not cause ducking to occur at any stage throughout the interaction with the user.

In those embodiments where the process 900 may cause ducking, the process 900 may vary the amount of ducking during voice input based on the perceptual loudness of the room at the moment of input. If, for example, music is playing at a high volume, the process 900 may significantly (e.g., >20%) duck the playback volume during voice input. However, if music is playing at a volume low enough that the user can comfortably converse over it (e.g., converse without having to substantially raise one's voice to be heard), the process 900 may barely duck, if at all, during voice input.

Additionally or alternatively, the process 900 may cause ducking based on media content type. The inventors have recognized that, in many instances, music listening tends to be a lean-back activity, commanding only tertiary attention. For most home listening, it's acceptable to speak over background music, or to miss part of a song while playback is ducked. Accordingly, when playing back music, ducking is not as disruptive as compared to ducking while playing back a movie or listening to a podcast or an audiobook. The latter scenarios are lean-in activities and typically own a significant amount of the user's attention. Therefore, in such scenarios, ducking may be very disruptive to the experience, and the process 900 may only cause ducking to occur at high volumes.

FIG. 11A is a flow diagram of a process 1100 configured to output a feedback element to one or more corresponding playback devices in accordance with aspects of the disclosed technology. In some embodiments, for example, the process 1100 comprises one or more instructions stored in memory (e.g., the memory 216 of FIG. 2A) and executed by one or more processors (e.g., the processor 212 of FIG. 2A) of an NMD (e.g., the NMD 103 of FIGS. 2A and 6, the NMD 103a of FIG. 1) and/or a playback device (e.g., the playback device 102 of FIG. 2A, the playback devices 102b and/or 102j of FIG. 1) of a media playback system (e.g., the media playback system 100 of FIG. 1). In certain embodiments, the process 1100 comprises instructions stored on memory (e.g., the memory 616 of FIG. 6) stored on a computing device(s) (e.g., the remote computing device(s) 105 of FIG. 6) remote from a media playback system. FIG. 11B is a schematic diagram illustrating aspects of the process 1100 of FIG. 11A.

Referring to FIGS. 11A and 11B together, at block 1110, the process 1100 receives voice input from a user via one or microphones (e.g., the microphones 224 of FIG. 2A) as described above, for example, with respect to FIG. 5B. As shown for example in FIG. 10B, the process 1100 can receive a voice input 1024 from a user via the playback device 102a.

At block 1120, the process 1100 determines a feedback element based on one or more of the feedback parameters detailed above, such as commands in the voice input data received at block 1110. As described in detail above with respect to FIGS. 2A-9B, the process 1100 can determine, for example, that the voice input received at block 1110 includes a command request having a question (e.g., “what is the weather forecast for tomorrow in Seattle?” etc.). The process 1100 can determine a feedback element to output in response to the command request such as, for example, “The weather forecast in Seattle for tomorrow is sunny and a chance of showers with a high of 52 degrees and a low of 45 degrees.”

At block 1130, the process 1100 determines one or more playback devices for output of the determined feedback element(s). In some embodiments, the process 1100 can determine a playback device and/or NMD that is nearest the user and correspondingly cause the determined playback device to output the feedback element. Determination of the playback devices for output of the determined feedback element(s) is discussed below in greater detail with reference to FIGS. 12A-12D.

At block 1140, the process 1100 causes output of the feedback element(s) determined at block 1120 via one or more corresponding playback devices (e.g., playback devices, NMDs, audio/video devices, televisions, control devices). In some embodiments, the process 1100 causes output of the feedback element via a control device (e.g., the control device 104 of FIG. 4A) that includes an audio feedback element and/or a visual feedback element played back via the control device.

In the illustrated embodiment of FIG. 11B (e.g., a home theater), for example, the playback device 102a is configured to output sound 1126 comprising audio content and/or the feedback element while the playback device 102b outputs audio content 1122 corresponding to video displayed on a television 1121 and the playback device 102j outputs the same audio content 1122. The process 1100 can be configured, for example, to play back audio content 1022 from the television 1021 via (i) a first playback device (e.g., the playback device 102b) at a first volume (ii) a second playback device (e.g., the playback device 102a) at a second volume; and (iii) a third playback device or the playback device 102j at the second volume. The first volume can be greater than the second volume. The process 1100, in response to determining a feedback element, can output, via the second playback device, the media content at a third volume less than the second volume, and the feedback element at a fourth volume that is lower than the first volume and the second volume, while the first and third playback devices continue to output the audio content 1122 at their respective first and second volumes. After the process 1100 finishes outputting the feedback element, the second playback device can resume playing back the audio content 1122 at the second volume level. Causing only the second playback device to output the feedback element can be beneficial for at least the reasons that the response request can be less distracting than if played back via all of the playback devices. Further advantages can include providing an “over the shoulder” whisper effect while watching video via the television 1121, and/or reducing or eliminating ducking effects, as described in greater detail below.

FIGS. 12A-12D are schematic diagrams illustrating further aspects of the process 1100 of FIG. 11A. The relative positioning of the playback devices shown in FIGS. 12A-12D is provided for ease of explanation; it will be appreciated that the process 1100 may be used with other configurations of playback devices (e.g., different positions relative to the speaker, in different rooms, etc.) and/or more or fewer than three playback devices (e.g., two playback devices, four playback devices, five playback devices, etc.).

In FIG. 12A, the media playback system (such as media playback system 100) includes a home theater environment having first and second playback devices (such as rear playback devices 102j and 102a, respectively, shown in FIG. 1) and a third playback device (such as front playback device 102b). The first, second, and third playback devices may be bonded, for example, as described with respect to FIGS. 3A-3D. In some aspects of the technology, the third playback device may be an NMD that is in communication with one or more VAS(es) (marked with a black square). The process 1100 may receive voice input at the third playback device, and cause output of one or more audio or visual feedback elements only at the third playback device (and not at the first and second playback devices). In other embodiments, the process 1100 may receive voice input at the third, voice-enabled playback device and cause output of one or more audio or visual feedback elements at only the first and second, non-voice enabled feedback devices (and not the third playback device). In some embodiments, the process 1100 may receive voice input at the third, voice-enabled playback device and cause output of one or more audio or visual feedback elements at the first, second, and third playback devices.

FIG. 12B shows another example of a media playback system (such as media playback system 100) including a home theater environment having first and second playback devices (such as rear playback devices 102j and 102a, respectively, shown in FIG. 1) and a third playback device (such as front playback device 102b). The first, second, and third playback devices may be bonded, for example, as described with respect to FIGS. 3A-3D. In some aspects of the technology, the first, second, and third playback devices may be NMD's, each of which are in communication with one or more VAS(es) (each marked with a black square). In some embodiments, one or more of the playback devices are not bonded, and at least two of the playback devices are in communication with different VAS(es). The process 1100 may receive voice input at one, some, or all of the first, second, and third playback devices, and cause output of one or more audio or visual feedback elements at at least one of the first playback device, the second playback device, and the third playback device. In some embodiments, the process 1100 may receive voice input at one, some, or all of the first, second, and third playback devices, and cause output of one or more audio or visual feedback elements at less than all of the first, second, and third playback devices.

In those embodiments where all of the playback devices are voice-enabled (such as that shown in FIG. 12B), the process 1100 may select one or more of the voice-enabled playback devices for output of the one or more feedback elements. The process 1100 may select the playback device(s) based on a variety of factors, such as proximity of the playback device to the user and/or location of the playback device relative to the user, another one or more playback devices, and/or the visual output device (e.g., a television, a projector screen, etc.). For instance, the process 1100 may determine that the first playback device is closer to the user than the second and third playback devices (for example, if the user is sitting at the left side of the couch) and, based on that determination, the process 1100 may cause the feedback element(s) to be output on the first playback device. As another example, the process 1100 may determine, based on information related to the bonded configuration of the first, second, and third playback devices, that the third playback device is closest to the visual output device (e.g., the television) and, based on that determination, the process 1100 may cause the feedback element(s) to be output on the third playback device. The inventors have recognized that outputting the feedback element(s) through the playback device closest to the visual output device is generally preferred by the user, as the user is more accustomed to receiving an audio feedback element from a playback device at the center of their visual attention rather than one that is out of sight.

FIG. 12C shows another example of a media playback system (such as media playback system 100) including a home theater environment having first and second playback devices (such as rear playback devices 102j and 102a shown in FIG. 1) and a third playback device (such as front playback device 102b). The first, second, and third playback devices may be bonded, for example, as described with respect to FIGS. 3A-3D. In some aspects of the technology, the first and second playback devices may be NMD's that are in communication with one or more VAS(es) (each marked with a black square). The process 1100 may receive voice input at the first and/or second playback device, and cause output one of or more audio or visual feedback elements only at the first and/or second playback device (and not at the third playback device). In other embodiments, the process 1100 may receive voice input at the first and/or second voice-enabled playback devices and cause output of one or more audio or visual feedback elements at only the third, non-voice enabled feedback device (and not the first and/or second playback devices). In some embodiments, the process 1100 may receive voice input at the first and/or second voice-enabled playback devices and cause output of one or more audio or visual feedback elements at the first, second, and third playback devices.

FIG. 12D shows another example of a media playback system (such as media playback system 100) including a home theater environment having first and second playback devices (such as rear playback devices 102j and 102a, respectively, shown in FIG. 1). The first and second playback devices may be bonded, for example, as described with respect to FIGS. 3A-3D. In some aspects of the technology, the first and second playback devices may be NMD's, each of which are in communication with one or more VAS(es) (each marked with a black square). In some embodiments, the first and second playback devices are not bonded and are in communication with different VAS(es). The process 1100 may receive voice input at one or both of the first and second playback devices, and cause output of one or more audio or visual feedback elements one or both of the first and second playback devices (for example, in unison). In some aspects of the technology, the process 1100 may select one or both of the voice-enabled first and second playback devices for output of the one or more feedback elements based on a variety of factors, such as proximity of the playback device to the user and/or location of the playback device relative to the user, the other of the playback devices, and/or the visual output device (e.g., a television, a projector screen, etc.).

In any of the above configurations, the process 1100 may cause a visual feedback element (e.g., an LED) to be output on one, some, or all of the non-voice enabled playback device(s) in conjunction with an audio feedback element being output from a voice enabled playback device(s). In such embodiments, the visual feedback element may be output at the same time as the audio feedback element, or may be output at a different time than the audio feedback element (e.g., non-overlapping times or overlapping times of different durations). The visual feedback element may also be output on the voice enabled playback device in addition to output on the non-voice enabled playback devices.

While the methods and systems have been described herein with respect to media content (e.g., music content, video content), the methods and systems described herein may be applied to a variety of content which may have associated audio that can be played by a media playback system. For example, pre-recorded sounds which might not be part of a music catalog may be played in response to a voice input. One example is the voice input “what does a nightingale sound like?” The media playback system's response to this voice input might not be music content with an identifier and may instead be a short audio clip. The media playback system may receive information associated with playing back the short audio clip (e.g., storage address, link, URL, file) and a media playback system command to play the short audio clip. Other examples are possible including podcasts, news clips, notification sounds, alarms, etc.

### VII. CONCLUSION

The description above discloses, among other things, various example systems, methods, apparatus, and articles of manufacture including, among other components, firmware and/or software executed on hardware. It is understood that such examples are merely illustrative and should not be considered as limiting. For example, it is contemplated that any or all of the firmware, hardware, and/or software aspects or components can be embodied exclusively in hardware, exclusively in software, exclusively in firmware, or in any combination of hardware, software, and/or firmware. Accordingly, the examples provided are not the only way(s) to implement such systems, methods, apparatus, and/or articles of manufacture.

The specification is presented largely in terms of illustrative environments, systems, procedures, steps, logic blocks, processing, and other symbolic representations that directly or indirectly resemble the operations of data processing devices coupled to networks. These process descriptions and representations are typically used by those skilled in the art to most effectively convey the substance of their work to others skilled in the art. Numerous specific details are set forth to provide a thorough understanding of the present disclosure. However, it is understood to those skilled in the art that certain embodiments of the present disclosure can be practiced without certain, specific details. In other instances, well known methods, procedures, components, and circuitry have not been described in detail to avoid unnecessarily obscuring aspects of the embodiments. Accordingly, the scope of the present disclosure is defined by the appended claims rather than the forgoing description of embodiments.

When any of the appended claims are read to cover a purely software and/or firmware implementation, at least one of the elements in at least one example is hereby expressly defined to include a tangible, non-transitory medium such as a memory, DVD, CD, Blu-ray, and so on, storing the software and/or firmware.

We claim:

1. A network microphone device, comprising:
one or more processors;
at least one microphone; and
tangible computer-readable memory storing instructions that, when executed by the one or more processors, cause the network microphone device to perform operations for determining whether to output a feedback element, the operations comprising:
receiving voice input data via the at least one microphone;
determining whether the voice input data comprises a valid wake word; and
causing, in response to determining whether the voice input comprises the valid wake word, output of the feedback element only if the voice input data comprises the valid wake word and at least one command request.

2. The network microphone device of claim 1, further comprising:
a network interface,
wherein the instructions for determining that the voice input data comprises a valid wake word further comprise:
receiving, via the network interface, an indication from a voice assistant service that the received voice input data comprises the valid wake word.

3. The network microphone device of claim 1, wherein the instructions further include instructions for:
suppressing, in response to determining whether the voice input data comprises a valid wake word, output of the feedback element in the absence of the valid wake word in the voice input data.

4. The network microphone device of claim 4, further comprising:
a network interface,
wherein the instructions for determining whether the voice input data comprises a valid wake word include:
receiving, via the network interface from a voice activity service, a message indicating a valid wake word is absent from the voice input data, and
wherein suppressing output of the feedback element occurs in response to the received message.

5. The network microphone device of claim 1, wherein the instructions further include instructions for:
determining, in response to determining whether the voice input data comprises the valid wake word, whether the voice input further comprises the at least one command request; and
causing, in response to determining whether the voice input further comprises the at least one command request, output of the feedback element.

6. The network microphone device of claim 1, wherein the instructions further include instructions for:
delaying output of the feedback element a time after determining whether the voice input data comprises the valid wake word and determining whether the voice input data comprises the at least one command request.

7. The network microphone device of claim 1, wherein the instructions further include instructions for:
determining, in response to determining whether the voice input data comprises a valid wake word, whether the voice input data includes a command request if the voice input data comprises the valid wake word; and
suppressing, in response to determining whether the voice input data comprises a command request, output of the feedback element in the absence of a command request in the voice input data.

8. A network microphone device of a media playback system, comprising:
one or more processors;
at least one microphone; and
tangible computer-readable memory storing instructions that, when executed by the one or more processors, cause the network microphone device to perform operations for determining a feedback element, the operations comprising:
receiving voice input data via the at least one microphone;
determining a type of command request in the voice input data;
determining, in response to determining the type of command request in the voice input data, a feedback element corresponding to the determined type of command request; and
in response to determining the feedback element, causing, via the media playback system, output of the feedback element.

9. The network microphone device of claim 8, wherein the instructions further include instructions for:
determining a category of media content output via at least one playback device of the media playback system,
wherein determining the feedback element further comprises determining the feedback element corresponding to the determined type of command request and the determined category of media content.

10. The network microphone device of claim 8, wherein the instructions further include instructions for:
determining at least one playback device of the media playback system associated with the feedback element,
wherein causing output of the feedback element comprises causing output of the feedback element at the at least one playback device associated with the feedback element.

11. The network microphone device of claim 10, wherein the instructions for determining the at least one playback device of the associated with the feedback element comprises determining that the network microphone device is associated with the feedback element.

12. The network microphone device of claim 10, wherein the instructions for determining at least one playback device of the associated with the feedback element comprises determining at least one playback device of the media playback system separate from the network microphone device is associated with the feedback element.

13. The network microphone device of claim 12, wherein the instructions for causing output of the feedback element comprises:
causing the at least one playback device separate from the network device to perform an action corresponding to the command request in the absence of a feedback element output at the network microphone device.

14. The network microphone device of claim 8, wherein the instructions for causing output of the feedback element comprises:
performing an action corresponding to the command request in the absence of a feedback element.

15. The network microphone device of claim 8, wherein the instructions for causing output of the feedback element comprises:
output a text to speech output corresponding to the command request in the absence of a feedback element.

16. A media playback system, comprising:
a first playback device; and
a second playback device, wherein the second playback device includes:
at least one microphone;
one or more processors; and
tangible computer-readable memory storing instructions that, when executed by the one or more processors, cause the network microphone device to perform operations for outputting a feedback element, the operations comprising:
receiving voice input data via the at least one microphone;
determining a feedback element corresponding to a command request in the voice input data; and
causing, in response to the determining the feedback element, output of the determined feedback element, wherein causing output of the feedback element comprises, during playback of media content via the first playback device and playback of the same media content via the second playback device, causing output of the feedback element via the second playback device in the absence of output of the feedback element via first playback device.

17. The media playback system of claim 16, wherein the instructions further include instructions for:
playing back, via the second playback device, the media content at a second volume level while the media content is played back via the first playback device at the first volume level,
wherein causing output of the feedback element further comprises:
reducing playback of the media content via the second playback device from the second volume level to a third, lower volume level; and
outputting, via the second playback device, the feedback element at a fourth volume level while the media content plays back via the first playback device at the first volume level and via the second playback device at the third volume level.

18. The media playback system of claim 17, wherein the instructions further include instructions for:
resuming, via the second playback device after the output of the feedback element, output of the media content at the second volume level while the first playback device continues to playback the media content at the first volume level.

19. The media playback system of claim 17, wherein causing output of the feedback element further comprises outputting, via the second playback device, the feedback element at the fourth volume level while playing back, via the second playback device, the media content at the third volume level in synchrony with the media content playing back, via the first playback device, at the first volume level.

20. The media playback system of claim 17, further comprising:
a third playback device,
wherein the instructions further include instructions for:
playing back, via the third playback device, the media content at the second volume level, and
wherein causing output of the feedback element further comprises outputting, via the second playback device, the feedback element at the fourth volume level while the media content plays back via the third playback device at the second volume level.
